(19) United States
(12) Patent Application Publication
(10) Pub. No.: US 2026/0122081 A1
(43) Pub. Date: Apr. 30, 2026

(54) AUTOMATED ANOMALY DETECTION

(71) Applicant: Entanglement, Inc., Miami, FL (US)

(72) Inventors: Haibo WANG, Laredo, TX (US); Richard T. HENNIG, Westminster, CO (US); Rajesh CHAWLA, Arvada, CO (US); Amit HULANDAGERI, Miami, FL (US); Amit VERMA, Miami, FL (US)

(73) Assignee: Entanglement, Inc., Miami, FL (US)

(21) Appl. No.: 19/376,225

(22) Filed: Oct. 31, 2025

Related U.S. Application Data
(60) Provisional application No. 63/714,402, filed on Oct. 31, 2024.

(51) Int. Cl. H04L 9/40

(52) U.S. Cl. CPC H04L 63/1416

(57) ABSTRACT

Systems and methods are described for automated anomaly detection in computer networks using a dynamic network graph. Network data describing communications among computing entities are received, and a dynamic graph is constructed and maintained whose nodes represent the entities and whose edges represent observed communications. Behavior characteristics are computed for the nodes, and the nodes are clustered using a clustering algorithm to obtain cluster assignments. Anomalies are detected by identifying nodes whose behavior characteristics deviate from those of their assigned clusters, and alerts or security actions are generated in response. The system supports incremental updates to graph structure and cluster assignments as network conditions evolve, improving detection latency and accuracy.

### CROSS-REFERENCE TO RELATED APPLICATION

This application claims the benefit of U.S. Provisional Patent Application No. 63/714,402 , filed Oct. 31, 2024, titled “AUTOMATED ANOMALY DETECTION”. The entire contents of the foregoing provisional application are incorporated herein by reference.

### BACKGROUND

Traditional computer systems have inherent and hard to find vulnerabilities that can allow unpermitted access to these systems. Threat detection is often provided to try to identify when the unpermitted access is initiated. However, by the time that the fraudster has access to the computer system, it may be too late to remediate the unpermitted access and further protect the sensitive data and corresponding systems. Better methods are needed.

### BRIEF DESCRIPTION OF DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a computer system for performing automated threat detection, in accordance with some of the embodiments disclosed herein.

FIG. 2 is a diagram showing a logical architecture for performing threat detection, in accordance with some of the embodiments disclosed herein.

FIG. 3 is an illustrative process of unsupervised machine learning model for generating labeled training data for a supervised machine learning model, in accordance with some of the embodiments disclosed herein.

FIG. 4 is an illustrative inference process using a supervised machine learning model, in accordance with some of the embodiments disclosed herein.

FIG. 5 is a diagram showing a logical architecture for performing graph anomaly detection, in accordance with some of the embodiments disclosed herein.

FIG. 6 is a diagram showing a logical architecture for performing anomaly clustering, in accordance with some of the embodiments disclosed herein.

FIG. 7 is a diagram showing a logical architecture for scaling of the automated threat detection system, in accordance with some of the embodiments disclosed herein.

FIG. 8 is an example threat detection display, in accordance with some of the embodiments disclosed herein.

FIG. 9 is an example threat detection display, in accordance with some of the embodiments disclosed herein.

FIG. 10 is an example threat detection display, in accordance with some of the embodiments disclosed herein.

FIG. 11 is an example threat detection display, in accordance with some of the embodiments disclosed herein.

FIG. 12 is a diagram showing a computer method and database connections for monitoring network threats, in accordance with some of the embodiments disclosed herein.

FIG. 13 is a process for performing graph anomaly detection, in accordance with some of the embodiments disclosed herein.

FIG. 14 is a process for performing anomaly clustering, in accordance with some of the embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

In some examples, the system receives various types of unlabeled data, including network data. The system determines, through an unsupervised machine learning model, a label for the data (e.g., “1” for outlier data and “0” for normal data). The labels are provided to a supervised machine learning model during a first training process. When new data is received, the supervised machine learning model is executed during an inference process to cluster the new data in accordance with the labels that were determined by the unsupervised machine learning model. In some examples, a label audit process may be implemented to update the cluster/output of the supervised machine learning model. The updated labels from the label audit process may be provided back to the supervised machine learning model during a second training process. In other words, the system may combine the unsupervised machine learning model with a supervised machine learning model to perform automated threat detection.

In some examples, the system implements a label audit process using a series of quadratic unconstrained binary optimization (QUBO) problems with a solver program, solving the series of QUBO problems with a quantum or quantum-inspired computer.

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

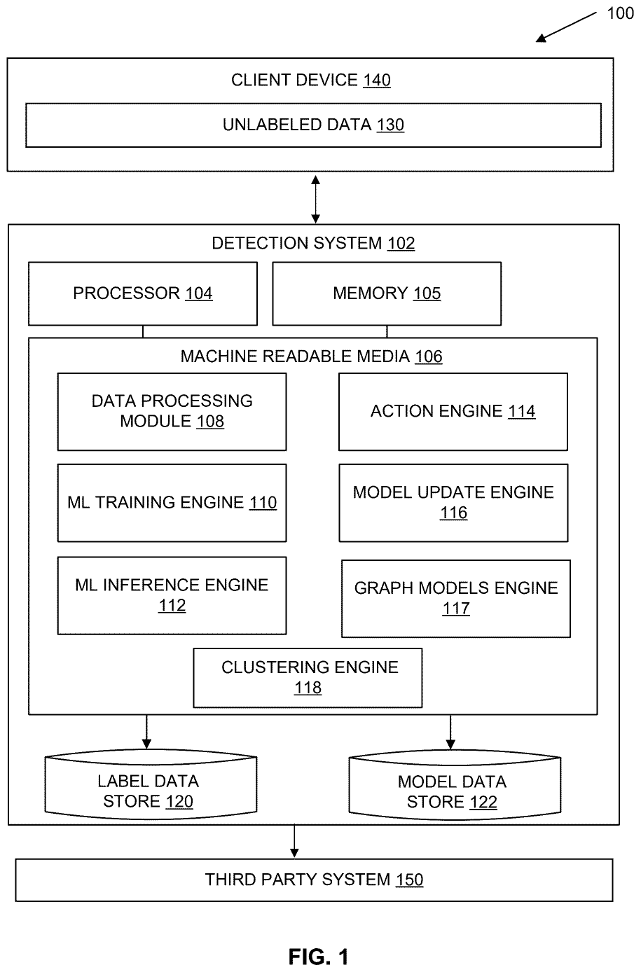

FIG. 1 is a computer system for performing automated threat detection, in accordance with some of the embodiments disclosed herein. Example 100 illustrates an example environment for anomaly detection in a computer network. Example 100 may include a plurality of computing entities that exchange information across one or more communication links. In operation, detection system 102 receives network data (e.g., over successive time intervals) describing those communications and uses the network data to construct and maintain a dynamic network graph for analysis. A computing entity may include any networked device, user endpoint, or service instance capable of transmitting or receiving networked data. For example, a client device 140 may represent an instance of a computing entity that appears as a node in a dynamic network graph.

As used herein, the term “network data” refers to any data associated with the operation or monitoring of a computer network. Network data may include, for example, telemetry such as packet or flow records, authentication events, system or application logs, and name-service records, as well as other information describing communications or relationships among networked computing entities. Network data can be live or historical, streamed or batched, and may be used to construct and update the dynamic network graph described herein.

As used herein, “behavior characteristics” are features or statistics describing networked computing entities that are based at least in part on the dynamic network graph (e.g., node-or community-level measurements) and may additionally incorporate features computed directly from the network data (e.g., traffic or authentication statistics). Behavior characteristics can be computed and refreshed over successive time intervals as the network data changes. In certain embodiments, the system clusters nodes by solving a QUBO formulation whose objective encodes clustering based on the behavior characteristics, and the solution yields cluster assignments for the nodes in the dynamic network graph. The system can employ different clustering algorithms over the behavior characteristics, including density-based methods (e.g., DBSCAN, HDBSCAN) and centroid-based methods (e.g., k-means). These algorithms may be configured for streaming or batched updates and may be selected based on latency, data scale, and/or cluster-shape features. In some embodiments, a label auditing stage uses a QUBO model to judge or validate the cluster assignments produced by one or more fast clustering algorithms (e.g., DBSCAN, HDBSCAN, k-means) and, when indicated, to adjust ambiguous assignments. In some embodiments, feature selection is performed prior to or during inference. Feature selection may use recursive, univariate, or other classical methods; however, for high-dimensional datasets (e.g., hundreds of features), the system may formulate feature selection as a QUBO and solve it using a quantum or quantum-inspired solver (e.g., Next Generation Quantum (NGQ) solver) to identify a subset of features that improves clustering quality and computational efficiency.

The dynamic network graph comprises nodes representing computing entities and edges representing observed communications among those entities. The graph is dynamic in that its nodes and edges may be created, removed, or updated as the network data changes over time. Subsequent processing modules, such as clustering and anomaly-detection engines described below, operate on this dynamic network graph to identify anomalous behavior. The detection system 102 is configured to construct and maintain a dynamic network graph whose nodes represent computing entities and whose edges represent observed communications, and the graph is updated as the network data changes.

In example 100, detection system 102 comprises processor 104, memory 105, and machine readable media 106. Detection system 102 may be a server computer that communicates via network communications to other devices accessible on the network, including client device 140 and third party system 150. Detection system 102 may receive unlabeled data 130 (e.g., network traffic, sensor data, firewall data, IoT data, or other telemetry data) from client device 140 and third party system 150 in a distributed communication environment.

Processor 104 may comprise a general-purpose or special-purpose processing engine such as, for example, a microprocessor, controller, or other control logic. Processor 104 may be connected to a bus, although any communication medium can be used to facilitate interaction with other components of detection system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable detection system 102 to perform features or functions of the disclosed technology as discussed herein. For example, the interfaces, circuits, and modules of machine readable media 106 may comprise, for example, data processing module 108, ML training engine 110, ML inference engine 112, action engine 114, model update engine 116, graph models engine 117, and clustering engine 118.

Data processing module 108 is configured to receive data from client device 140, including end user devices, sensors, or software systems. The source of the data may comprise sensors, IoT devices, satellite, third party entities (e.g., Netflow, Zeek, CrowdStrike, vpcFlow, Elk, Splunk, cloud storage sources, Tanium, ICS, SCADA, or Tenable), or other end user devices. The format of the data may comprise a structured format, such as JSON, XML, or binary. In some examples, the data is ingested by collecting, receiving, and storing the data generated by the client device. Data processing module 108 may invoke pre-processing which constructs the dynamic network graph.

In some examples, the data may comprise various telemetry data, including streaming or batched data. The term “telemetry” may correspond with remote measurement and transmission of information about the client device. In some examples, the data may include information about the performance, security, status, and behavior of the client device.

The data may be generated by client device 140 corresponding to a sensor, IoT device, server, network equipment, or application installed at client device 140. In some examples, the source of the data may continuously generate the data, which is transmitted via a network to detection system 102 and processed by data processing module 108. The transmission of the data may be transmitted using different protocols like HTTP, MQTT, or custom protocols specific to the application or industry of the particular embodiment.

In some examples, the data received by client device 140 is unlabeled data. The information received with the data can include a data packet header, payload, or metadata that is added during the transmission of the data. In this sense, the data packet header, payload, or metadata that is added during the transmission of the data may not correspond with the label added by detection system 102 later in the process. Instead, the label added by detection system 102 may correspond with data characteristics of the data that can identify the type of data upon analysis of the data packet, and the label added by detection system 102 may not be provided with the data as it is received by detection system 102.

ML training engine 110 is configured to train both unsupervised machine learning models and supervised machine learning models. Various training methods are described herein and implementation of any of these training methods will not divert from the essence of the disclosure.

In some examples, the unsupervised machine learning model may correspond with clustering (e.g., k-means, hierarchical clustering), dimensionality reduction (e.g., PCA, t-SNE), association rule learning, or other unsupervised machine learning models. When clustering is implemented, the process may identify natural groupings or clusters in the data, based on a data characteristic, and generate a label associated with that characteristic. When dimensionality reduction is implemented, the process may reduce the number of input variables or features under consideration to simplify the complexity of the dataset by transforming it into a lower-dimensional space while preserving important information. When association rule learning is implemented, the process aims to discover relationships, patterns, or associations within the unlabeled data, and generate a label for the corresponding data. In any of these instances, the unsupervised machine learning model may generate or assign a label that corresponds with “1” for outlier data and “0” for normal data.

The unsupervised machine learning models may be trained on unlabeled data to assign or generate a label for the unlabeled data. The unlabeled data may be received without labeled outputs or target variables. In an illustrative example, the data may comprise security logs from client device 140 and the unsupervised machine learning model may be trained to label the data. The labels may correspond with “1” (yes, a security log) or “0” (not a security log) and may be assigned by the unsupervised machine learning model. In another example, the label may correspond with “1” (e.g., normal data) or “0” (e.g., outlier data) based on the characteristics of the data. In another example, the label may correspond with multiple values, including a value associated with one or more data characteristics (e.g., non-binary label). The label determined during the training process may be stored in label data store 120.

In some examples, the unsupervised machine learning model may identify new data types that are included with the unlabeled data from client device 140. When new data is identified (e.g., when the characteristics of the data do not match pre-existing data characteristics that are previously assigned to labels), a new label may be generated and assigned to the unlabeled data. The label that is generated during the training process may be stored in label data store 120.

In some examples, the unsupervised machine learning model may determine a new label associated with outliers in the data. The outlier may correspond with data that is not similar to previously identified activities in the system, including non-fraudulent or fraudulent activities, and a label corresponding with the outlier may be generated and assigned to the data.

ML training engine 110 is also configured to train a supervised machine learning model. The supervised machine learning model may be trained using the label that was determined from the unsupervised machine learning model and stored in label data store 120.

In some examples, the supervised machine learning model may correspond with logistic regression, decision trees, support vector machines, neural networks, or other supervised machine learning models. Training the supervised machine learning model may begin by initializing the model with random or predefined parameters that can be adjusted during the training. When the label that was determined from the unsupervised machine learning model is provided as input to the supervised machine learning model (e.g., by accessing label data store 120), the process iteratively adjusts parameters of the model to minimize the difference between its predictions and the true labels. In some examples, a loss function may also be implemented to quantify the error between the predicted outputs and the true labels. The loss function may be minimized during training.

In some examples, an optimization function is implemented to adjust the parameters of the model iteratively. An illustrative process to adjust the parameters is gradient descent, although various optimization functions may be implemented. In some examples, the gradient of the loss function may be calculated with respect to the model parameters. The parameters may be updated in the opposite direction of the gradient to minimize the loss.

The trained supervised machine learning model may be stored in a model data store 122 as a trained machine learning model. The trained machine learning model may be used during an inference process when new unlabeled data is received by detection system 102.

ML inference engine 112 is configured to initiate an inference process using the trained models stored in model data store 122. The trained machine learning model may make predictions or generate outputs for new unlabeled data. For example, once the supervised machine learning model is trained on a labeled dataset (e.g., that has been labeled using the unsupervised machine learning model), the machine learning models stored in model data store 122 can be deployed for inference of the new data.

The inference process may comprise, for example, providing the unlabeled data to the trained model as input. The processing of the data may vary based on the type of model to be associated with the unlabeled data. For example, in a neural network, the model may receive the unlabeled data as input and process it through the layers of the neural network to generate output. The output of the neural network may provide determined similarities between previously received data and new data (e.g., whether the new data is similar or not similar to the previously received data with respect to a similarity threshold). In decision trees, the model may receive the unlabeled data as input and process it through its decision boundaries. In either of these implementations, the model may generate a prediction as output of the unlabeled data.

ML inference engine 112 is also configured to generate a set of clusters of labeled data as the prediction/output of the model. In creating the set of clusters, the model may apply the learned patterns and relationships determined during training to the new data. In some examples, the model may generate clustered data with the highest probability of corresponding with the unlabeled data, and group each set of similar data (within a similarity threshold) in the common cluster. In some examples, the output may comprise a confidence score that the data corresponds with the particular cluster (e.g., normal data) or does not correspond with any cluster (e.g., outlier data).

ML inference engine 112 is also configured to generate a confidence score associated with the inference process for the likelihood that the unlabeled data is to be grouped in the clustered data. The confidence score may identify the probability that the supervised machine learning model assigns to the prediction or classification.

Various confidence scores may be implemented. For example, a confidence score may be determined for each cluster and the greatest confidence score associated with the particular cluster may determine which cluster the data are assigned. In other examples, confidence score for a positive cluster may exceed a predetermined threshold (e.g., 0.5), the supervised machine learning model might predict it as the positive cluster/group. Otherwise, the supervised machine learning model may predict the opposite or a negative cluster/group. In this sense, the confidence score may be used as a thresholding for classification.

In some examples, the confidence score may correspond with the determination that the unlabeled data is outlier data. In other words, the unlabeled data corresponds with data that is previously unlabeled and not similar to other previously labeled data in the system. A correlation may exist between the confidence score and the determination of outlier data, including an instance when the data is not similar to existing data. In some examples, an action may be recommended or initiated (e.g., to remedy a potential threat).

Action engine 114 is configured to initiate an action in association with the data received from the client device. For example, in response to detecting a threat or unpermitted access to the client device in the data, or in response to identifying outlier data, the action may be initiated. In some examples, the action may be to add the data to an outlier queue for further review.

In some examples, the action corresponds with remediating the detected threat. In some examples, the action may refer to the steps taken to mitigate or eliminate a network threat once it has been identified, which can provide a technical improvement for the system overall. The system may respond quickly to a network threat to improve cybersecurity, minimize potential damage, and potentially prevent further compromise.

The action may comprise initiating an isolation of the affected systems to prevent the threat from spreading further. This might involve disconnecting or transmitting an alert to recommend disconnecting the compromised client device from the network. In other examples, the action may implement network segmentation to separate or contain the impact of the detected threat.

The action may comprise a recommendation to initiate an investigation to understand the nature and scope of the threat. The action may involve analyzing data/security logs, network traffic, or other sources. The investigation may help identify the source, methods, and potential impact of the threat. In other examples, the investigation may help determine the vulnerabilities that allowed the threat to access the client device. For example, the action can identify outdated software, misconfigurations, or other weaknesses in the network infrastructure, suggest updating patches or security tools, changing access credentials, or other actions in response to the detected threat.

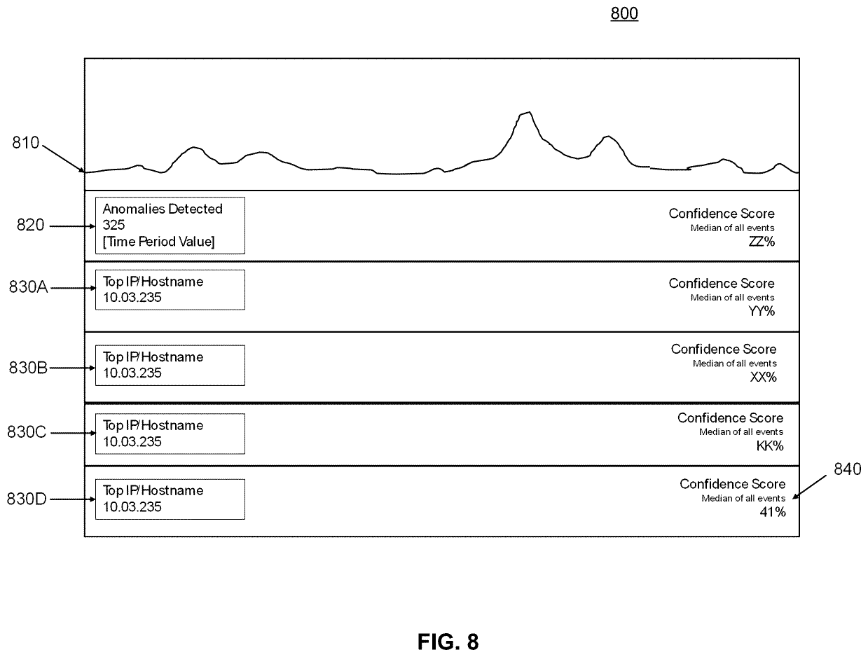

In some examples, the action may include updating an application programming interface (API), dashboard, or other display. Various examples of the API, dashboard, or display are provided with FIGS. 8-11.

Model update engine 116 is configured to review output from the supervised machine learning model and, in some examples, validate or update the results from the model. In some examples, the model update engine 116 may initiate a label auditing process. During the label auditing process, model update engine 116 may revise labels associated with particular data or data characteristics. For example, the data associated with the label may be measured for similarity. The data value that is greater than a predetermined threshold value may be provided for further review. In some examples, additional labels may be added by a human user to output from the supervised machine learning model.

In some examples, the labels that are determined during the label auditing process may be provided back to the supervised machine learning model to retrain the model during a second training process. The retrained supervised machine learning model may be stored in model data store 122 and/or provided for future inference processes on new data that is received from client device 140. In some examples, the label audit process may use a series of QUBO problems with a solver program, solving the series of QUBO problems with a quantum or quantum-inspired computer. The role of QUBO and the corresponding solver in this context is to address complex optimization challenges inherent in the labeling process. For example, as the system processes large volumes of data, it may encounter ambiguous or borderline cases where the initial labels assigned by the machine learning models could be uncertain or imprecise. QUBO provides a structured approach to resolving these ambiguities by finding the optimal configuration of labels that minimizes errors and maximizes the consistency of labeled data across the dataset. Once the QUBO solutions are obtained, the labeling results are updated and the model is retrained and further refined based on the updated labels. This iterative evolvement influences the performance of the supervised machine learning models for detecting anomalies and potential cybersecurity threats.

Graph models engine 117 is configured to perform various functions related to computer network graphing in the realm of cybersecurity, including implementing graph anomaly detection. As referred to herein, graph anomaly detection is a technique utilized in the realm of cybersecurity and involves the analysis and monitoring of network traffic and system activities that are represented in schematic form, for instance as a computer network diagram (e.g., network graph). Graph anomaly detection operates on the principle that when a computer network is represented as a graph, individual devices (nodes) may exhibit behaviors that differ significantly from their peer nodes. These behavioral differences manifest as isolation patterns within the graph structure, where anomalous nodes become exhibit unusual connection patterns compared to similar nodes in their network community. By identifying these isolation nodes, the graph models engine 117 may detect devices that may be compromised, misconfigured, or exhibiting suspicious activity.

In some examples, the graph models engine 117 generates graphs which represent the structure of the communities within a monitored network, where the graphs are further analyzed in order to detect, or otherwise find, complex threats and vulnerabilities. With the graph models engine 117 performing graph anomaly detection, the detection system 102 is capable of identifying the source of a threat and predicting other connected nodes that could potentially be infiltrated by that threat. Detecting a threat's source, as well as anticipating the potential spread of that threat within a network (e.g., forecasting the infected nodes) are critical aspects for stopping a cyberattack in progress, and further enables the detection system 102 to operate in a manner that significantly accelerates the threat remediation process. In some implementations, the graph models engine 117 implements various features and capabilities that are related to graph anomaly detection, including but not limited to: community and anticommunity detection; identifying network topology changes over time; detecting lateral movement; discovering attack connections; and observing dataflow.

The graph models engine 117 may apply graph anomaly detection to computer network security by analyzing network graphs in conjunction with cluster assignments determined by clustering engine 118. In some embodiments, the graph models engine 117 identifies anomalous nodes by detecting devices whose behavioral profiles do not align with their QUBO-optimized cluster characteristics within the network graph structure, enabling detection of sophisticated threats that maintain normal connection patterns while exhibiting subtle behavioral anomalies across multiple dimensions.

The graph models engine 117 may monitor changes in network graph structure over time, detecting when the connectedness among nodes shifts dynamically. In some implementations, the graph models engine 117 coordinates with clustering engine 118 to trigger fast re-clustering algorithms when significant topological changes are detected, ensuring that anomaly detection remains accurate as network conditions evolve.

Clustering engine 118 is configured to perform clustering operations that support network-threat detection, including anomaly clustering. As used herein, anomaly clustering refers to techniques in which the system groups related anomalies or unusual patterns rather than treating each anomaly independently. By identifying clusters of anomalies that share common characteristics, the clustering engine 118 enables a more comprehensive view of abnormal behavior within the monitored network. In certain embodiments, the clustering engine 118 employs a quadratic unconstrained binary optimization (QUBO) model to assign nodes of the dynamic network graph to clusters based on behavior characteristics. The resulting cluster assignments are then provided to the anomaly-detection pipeline, which identifies nodes whose behavior deviates from the characteristics of their assigned cluster. The clustering engine 118 may obtain behavior characteristics computed from the intermediate metrics and the dynamic network graph to perform its clustering and anomaly-grouping operations.

In some implementations, the clustering engine 118 includes a machine-learning clustering model that groups similar events, such as anomalies or threats identified by the ML inference engine 112, based on shared attributes observed during the inference process. By intelligently clustering related anomalies, the clustering engine 118 reduces the effort required by analysts to review and classify potential threats and improves the overall interpretability of the detection output. By organizing related anomalies into clusters, the clustering engine 118 enables more efficient processing and correlation of network events, allowing subsequent components to evaluate potential threats with reduced computational overhead and improved detection precision compared to analyzing each anomaly independently.

In some embodiments, the clustering engine 118 implements a QUBO-based cluster-optimization approach that differs from conventional connectivity- or distance-based metrics by clustering network nodes according to multi-dimensional behavior characteristics rather than simple proximity. The behavior characteristics may include, for example, data-flow patterns, connection-frequency distributions, protocol-usage profiles, temporal communication behaviors, and other network attributes. This formulation allows the system to solve the clustering problem as a global optimization, producing stable, consistent cluster assignments even as the underlying network graph changes. The QUBO-based approach also supports incremental updates and can be executed on quantum or quantum-inspired hardware to accelerate computation across large, high-dimensional datasets. As a result, the clustering engine 118 provides a technical improvement in scalability, accuracy, and responsiveness for dynamic-graph anomaly detection systems.

The clustering engine 118 is further configured to handle dynamic network graphs where the connectedness among nodes changes over time. For example, the clustering engine 118 may implement fast algorithms optimized for dynamic graph clustering to enable real-time anomaly detection as network relationships evolve. The QUBO-based clustering approach may be adapted to efficiently recalculate cluster assignments when network topology or node behaviors change, allowing the system to maintain accurate anomaly detection capabilities in dynamic network environments. As such, the clustering engine 118 and graph models engine 117 may work together to implement fast algorithms specifically configured for dynamic graph clustering, enabling real-time anomaly detection as network relationships evolve. This dynamic clustering capability provides significant technical advantages for detection system 102, including faster threat detection response times compared to systems that rely on static clustering approaches. When the graph models engine 117 detects significant changes in network topology, it can immediately signal the clustering engine 118 to execute fast re-clustering algorithms, ensuring that anomaly detection baselines remain current. This coordinated approach may reduce false positive rates by maintaining accurate cluster boundaries that reflect current network conditions rather than outdated baselines, and enables detection of sophisticated threats that attempt to evade detection by gradually modifying their network behavior patterns over time.

Unlabeled data 130 may comprise any data that is received at detection system 102 via network communications from client device 140. In some examples, client device 140 may generate unlabeled data, including network traffic, sensor data, firewall data, IoT data, or other telemetry data. The labeling aspect of the unlabeled data may correspond with a machine learning model that has associated a particular label to the unlabeled data from client device 140, including an unsupervised machine learning model. The data generated by client device 140 may correspond with metadata or other characteristics of the data, without also corresponding with a label. In some examples, unlabeled data 130 may be aggregated and characterized by detection system 102 using data processing module 108 as described herein. In some examples, unlabeled data 130 is processed or filtered according to methods and systems described herein.

Client device 140 is configured to generate, transmit, and receive data from detection system 102. Client device 140 may be any end user devices, sensors, or software systems. The source of the data may comprise sensors, IoT devices, satellite, third party entities (e.g., Netflow, Zeek, CrowdStrike, vpcFlow, Elk, Splunk, cloud storage sources, Tanium, ICS, SCADA, or Tenable), or other end user devices. The format of unlabeled data 130 may comprise a structured format, such as JSON, XML, or binary. In some examples, unlabeled data 130 is ingested by collecting, receiving, and storing the data generated by client device 140.

Third party device 150 is configured to perform secondary analysis on the data associated with client device 140. In some examples, third party device 150 corresponds with Security Information and Event Management (SIEM) that provides a secondary analysis of security alerts generated by detection system 102. In some examples, SIEM may combine the alerts from detection system 102 with other security event data to perform monitoring, detection, and response actions for potential threats.

In some examples, third party device 150 corresponds with a cyber stack system that includes tools and data inventory related to cyber security. In some examples, the cyber stack system may comprise a device to evaluate software security, a device to evaluate the security practices of the developers and suppliers, and a device to analyze and provide feedback with respect to conforming the data/devices with secure practices.

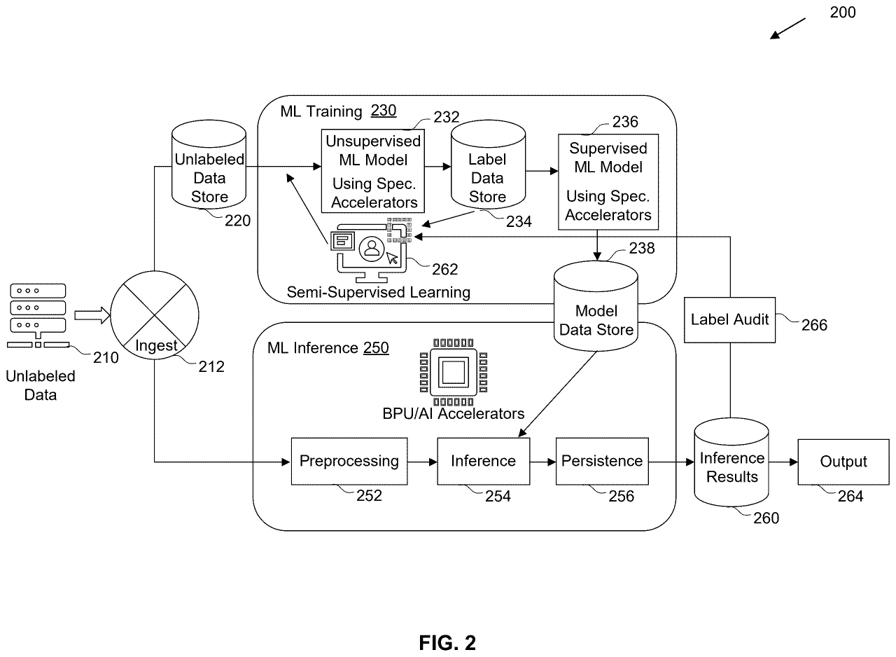

FIG. 2 is a diagram showing a logical architecture for performing automated threat detection, in accordance with some of the embodiments disclosed herein. In example 200, detection system 102 of FIG. 1 may execute machine-readable instructions to perform the operations described herein. FIG. 2 illustrates an example process flow for performing the anomaly-detection operations introduced above. Network data may be ingested at block 212, stored in an unlabeled data store 220 for training, and provided to pre-processing 252 for inference, where the dynamic network graph is constructed and behavior characteristics are computed. Pre-processing 252 may construct and update the dynamic network graph and produce intermediate metrics (e.g., normalized edge weights, per-node connection counts over a recent time window, and protocol/port histograms) that the inference engine uses as inputs to compute or update the behavior characteristics for nodes. Pre-processing or the inference pipeline may further perform feature selection. For high-dimensional inputs, feature selection may be formulated as a QUBO and solved using a quantum or quantum-inspired solver to select a subset of features that enhances clustering quality and reduces compute costs.

The inference, at block 254, may subsequently compute or update the behavior characteristics for the nodes based at least in part on the dynamic network graph, and applies the trained model(s) to detect anomalies. Although FIG. 2 depicts graph construction within the inference path, similar graph-based pre-processing may be used in the training path to generate training behavior characteristics for a model. Behavior characteristics are based at least in part on the dynamic network graph and may also incorporate statistics computed directly from the network data.

In some examples, specialized hardware is provided to execute one or more of the blocks illustrated herein. For example, the processes described herein may be implemented across multiple servers and using multiple architectures. In some examples, different accelerators and different hardware may be implemented to expedite processing.

At block 210, unlabeled data is received. The unlabeled data may include data from a client device, including end user devices, sensors, or software systems. The data may comprise various telemetry data, including streaming or batched data. The unlabeled data may correspond with remote measurement and transmission of information about the client device and, in some examples, may include information about the performance, security, status, and behavior of the client device. In some examples, the unlabeled data may include a data packet header, payload, or metadata that is added during the transmission of the data. In this sense, the data packet header, payload, or metadata that is added during the transmission of the data may not correspond with the label added later in the process (e.g., at block 232).

In some examples, the data may be generated by the client device by a sensor, IoT device, server, network equipment, or application associated with the client device. The source of the data may comprise sensors, IoT devices, satellite, third party entities, or other end user devices. In some examples, the source of the data may continuously generate the data. The transmission of the data may be transmitted using different protocols like HTTP, MQTT, or custom protocol.

At block 212, unlabeled data is ingested. For example, when the unlabeled data is telemetry data, the ingesting may include collecting, receiving, and incorporating raw data generated by the client device. The unlabeled data may include information regarding the performance, status, and behavior of these systems. The ingesting process may include storing the data in an unlabeled data repository or data store.

In some examples, the ingesting process may include a data acceptance and validation process to help ensure that incoming data is accurate, reliable, and consistent before the data are stored in the unlabeled data repository or data store. For example, the process may verify that the data adheres to predefined criteria, like data format, data type, and expected size. In another example, the integrity of the data may be analyzed to determine whether the data are altered or corrupted during transmission or storage. This may include checking for checksums, digital signatures, or hashing algorithms to verify data integrity. In other examples, the data are checked against predefined standards or schema to ensure that it aligns with the expected format, structure, and content, including a comparison to specific data models or industry standards.

In some examples, the ingesting process may include filtering, aggregation, and transformation. For example, filtering of the unlabeled data may remove specific subsets of data based on predefined criteria, like specific values, ranges, patterns, or characteristics within the unlabeled data. In another example, aggregation may combine information from multiple individual data points in the unlabeled data by summing, averaging, counting, or finding maximum or minimum values within groups or categories in the unlabeled data. In some examples, the unlabeled data may be converted to a different data type or protocol/format or added with missing values.

In some examples, the ingesting process may identify discrepancies or issues in the unlabeled data. The issues may be added to an audit log and may trigger an action (e.g., to retransmit the unlabeled data or restart the client device).

At block 220, ingested data is stored in the unlabeled data repository or data store. In some examples, the unlabeled data may be used as baseline data for multiple ML training processes (block 230). The unlabeled data may correspond with data received from the client device and labeled, at a first time, using the unsupervised machine learning model.

At block 230, the unlabeled data is used to train one or more machine learning models using a multi-step training process. These ML models, which may include unsupervised learning algorithms such as clustering, dimensionality reduction, or anomaly detection, are trained to identify patterns, group similar data points, and detect outliers or anomalies within the dataset. The ML training may be performed asynchronously with receiving the unlabeled data. In some examples, the training process comprises blocks 232, 234, 236, or 262, or any subset thereof. In examples, block 230 may be executed, for example, by the ML training engine 110 of FIG. 1.

At block 232, an unsupervised machine learning model is initiated. For example, the unsupervised machine learning model may correspond with clustering (e.g., k-means, hierarchical clustering), dimensionality reduction (e.g., PCA, t-SNE), association rule learning, or other unsupervised machine learning models. When clustering is implemented, the process may identify natural groupings or clusters in the data, based on a data characteristic, and generate a label associated with the data characteristic. When dimensionality reduction is implemented, the process may reduce the number of input variables or features under consideration to simplify the complexity of the dataset by transforming it into a lower-dimensional space while preserving important information. The reduction in the complexity of the dataset may help identify fewer labels by the unsupervised machine learning model. When association rule learning is implemented, the process aims to discover relationships, patterns, or associations within the unlabeled data, and generate a label for the corresponding data.

The unsupervised machine learning model may be trained on unlabeled data (received from block 220) to assign or generate a label for the unlabeled data. The unlabeled data may be received without labeled outputs or target variables. In an illustrative example, the label may correspond with “1” (e.g., outlier data) or “0” (e.g., normal data) based on the characteristics of the data. The label determined during the training process may be stored in a label data store (block 234).

In some examples, the unsupervised machine learning model may identify new data types that are included with the unlabeled data from the client device. When new data is identified (e.g., when the characteristics of the data do not match pre-existing data characteristics that are previously assigned to labels), a new label may be generated and assigned to the unlabeled data. The label that is generated during the training process may be stored in label data store (block 234).

In some examples, the unsupervised machine learning model may determine a new label associated with outliers in the data. The outlier may correspond with data that is not similar to previously identified activities in the system, including non-fraudulent or fraudulent activities, and a label corresponding with the outlier may be generated and assigned to the data.

At block 234, the labeled training data is generated by the unsupervised machine learning model at block 232 and stored in label data store.

At block 236, a training of a supervised machine learning model is initiated. For example, the supervised machine learning model may be trained using the label that was determined from the unsupervised machine learning model and stored in label data store (block 234).

In some examples, the supervised machine learning model may correspond with logistic regression, decision trees, support vector machines, neural networks, or other supervised machine learning models. The foregoing models are applied to network-security telemetry to learn baselines for computing entities and communities and to surface outliers indicative of misconfiguration, compromise, or policy violations. Training the supervised machine learning model may begin by initializing the model with random or predefined parameters that can be adjusted during the training. When the label that was determined from the unsupervised machine learning model is provided as input to the supervised machine learning model (e.g., by accessing label data store 120), the process iteratively adjusts parameters of the model to minimize the difference between predictions and the true labels. In some examples, a loss function may also be implemented to quantify the error between the predicted outputs and the true labels. The loss function may be minimized during training.

In some examples, an optimization function is implemented to adjust the parameters of the model iteratively. An illustrative process is gradient descent, although various optimization functions may be implemented. In some examples, the gradient of the loss function may be calculated with respect to the model parameters. The parameters may be updated in the opposite direction of the gradient to minimize the loss. The ML training module may output a trained ML model to model data store 238. The trained machine learning model may be used during an inference phase of the machine learning model when new unlabeled data is received.

In some embodiments, the labeled training data generated by the unsupervised machine learning model may undergo re-balancing and/or synthetization to improve its quality. Techniques such as oversampling, undersampling, or using weighted classes may be employed to address imbalances in the data, which can occur in the distribution of clusters or other groupings. This newly generated data can help prevent biased inferences by ensuring that the training data is more representative and balanced. Additionally, synthetization methods, such as Synthetic Minority Over-sampling Technique (SMOTE), data augmentation, Generative Adversarial Networks (GANs), or autoencoders, may be used to generate new synthetic data that enriches the training set. This process helps prevent biased inferences and improves the model's ability to generalize from the data. The trained machine-learning models may subsequently be deployed for inference on live network data received through the pre-processing pipeline to identify anomalies in real time. At block 250, an inference process may be initiated using the trained machine learning model. In some examples, the data is used to infer threats and to help implement automated threat detection. In some examples, the inference process comprises blocks 252, 254, and 256, or any subset thereof. In examples, block 250 may be executed, for example, by the ML inference engine 112 of FIG. 1.

For example, a graph model may be constructed based on unlabeled data (such as network flow, host telemetry, network topology, and log files) to represent the relationships and interactions between different entities within the network environment, and stored in model data store 238. The unlabeled data might be transformed into graphs where nodes represent devices, users, or applications, and edges represent the connections or interactions between these entities. The graph model allows the detection system to visualize and monitor the flow of information, detect unusual patterns, and identify potential security threats based on the relationships and dependencies within the network.

The trained ML models (e.g., those trained with supervised learning using labels generated by unsupervised methods) can cluster nodes within the graph model that exhibit similar behaviors, helping to identify communities or detect anomalies, such as unusual data flows between typically unrelated nodes. They also detect anomalies by highlighting nodes or edges in the graph that deviate from normal behavior, which can indicate potential security threats like unauthorized access or data exfiltration. Additionally, the output from the ML models allows the system to label specific nodes or edges in the graph as normal or suspicious, thereby providing more context for the graph-based analysis.

At block 252, the inference process may implement preprocessing of the data. For example, after the unlabeled data is ingested (block 212), the data may be partitioned and provided for preprocessing. The ingesting/preprocessing may remove specific subsets of data based on predefined criteria, combine information from multiple individual data points in the unlabeled data, or convert the data to a different data type or protocol/format or added with missing values. In some examples, the data may be split so that a first portion of the data is used for training (e.g., with block 230) and a second portion of the data is used for inference (e.g., with block 250).

Various preprocessing methods may be implemented. For example, the inference process may implement feature scaling to adjust the scale of the features to correspond to a similar range as each other. In some examples, the preprocessing includes dimensionality reduction to reduce the number of input features while preserving important information. The identification and reduction of input features may be implemented using PCA (Principal Component Analysis) or other feature selection methods. For example, a QUBO formulation can be used to optimize feature selection or clustering assignments by encoding feature relevance, similarity, and separation constraints into the QUBO objective. This approach allows the system to determine an optimal subset of features or cluster assignments that best represent the underlying structure of the dynamic network graph while reducing dimensionality and computational overhead. In some examples, the pre-processing stage normalizes the data from the ingesting process (block Docket 212) to help ensure that the incoming data is in the same format and range as the data used during model training.

At block 254, inference may be initiated by accessing one or more supervised ML models stored in model data store 238 and providing the data received from preprocessing (block 252) as input. The model may generate a set of clustered data in accordance with the labels that were determined by the unsupervised machine learning model.

The label associated with the data may be used to access a corresponding supervised ML model stored in model data store 238. As one illustrative example, particular telemetry data may be associated with a particular model stored in model data store 238. When new telemetry data is received that is similar to the previously received telemetry data, the new telemetry data may also be associated with the particular model stored in model data store 238 and the new data may be provided as input to the ML model.

At block 256, the process may initiate a persistence process. This process includes saving the detected anomalies in the data, ensuring that these identified issues are stored for further analysis and review.

At block 260, the inference results/output may be stored in a data store and, in some examples, initiate a label auditing process 266. During the label auditing process 266, the process may update labels associated with particular data or data characteristics. For example, the data associated with the label may be measured for similarity. The data value that is greater than a predetermined similarity threshold value may be provided for further review. In some examples, additional labels may be added by a human user to output from the supervised machine learning model.

In some examples, the label audit process 266 may use a series of QUBO problems with a solver program, solving the series of QUBO problems with a quantum or quantum-inspired computer. These quantum or quantum-inspired computers can solve QUBO problems more efficiently and accurately than traditional computer systems due to their ability to explore multiple solutions simultaneously, leveraging quantum superposition and entanglement. This capability allows them to navigate complex optimization landscapes more effectively, finding optimal or near-optimal solutions in a fraction of the time required by classical methods. The QUBO solutions may be used to further revise and finetune the labeling of the data for retraining of the ML models. In this context, QUBO is used to optimize label configurations (e.g., resolve borderline cases) during the label-auditing process. This use of QUBO for clustering is distinct from any QUBO-based label auditing, and operates directly on the behavior characteristics of nodes in the dynamic network graph.

In some examples, the labels that are determined during the label auditing process 266 may be provided back to a supervised machine learning model (block 262) to retrain the supervised machine learning model during a second training process (block 232). The retrained supervised machine learning model may be stored in model data store (block 238) and/or provided for future inference processes on new data. The output from the label auditing 266 may be used to implement automated detection of potential threats. The newly-discovered potential threats may be provided to a supervised machine learning module (block 262) for analysis and inclusion in the ML model.

At block 262, the supervised machine learning model may be retrained with the labels identified during the label auditing process 266 that may correspond with the fraudulent activity. The retrained model may be updated at block 232. Using the retrained model, any new data that is received/ingested may be received by supervised machine learning model. The pre-existing labeled data can be clustered with the previously-identified clusters and any new data that is not clustered can be identified as a new outlier.

At block 264, an action may be initiated. For example, in response to detecting a threat or unpermitted access to the client device in the data, the action may correspond with remediating the threat. In some examples, the action may refer to the steps taken to mitigate or eliminate a network threat once it has been identified, which can provide a technical improvement for the system overall. The system may respond quickly to a network threat to improve cybersecurity, minimize potential damage, and potentially prevent further compromise.

In some examples, the action may comprise initiating an isolation of the affected systems to prevent the threat from spreading further. This might involve disconnecting or transmitting an alert to recommend disconnecting the compromised client device from the network. In other examples, the action may implement network segmentation to separate or contain the impact of the detected threat. Alerts or actions may be conditioned on one or more policy thresholds (e.g., score cutoffs, risk tiers, or cluster-deviation significance levels).

The action may comprise a recommendation to initiate an investigation to understand the nature and scope of the threat. The action may involve analyzing data/security logs, network traffic, or other sources. The investigation may help identify the source, methods, and potential impact of the threat. In other examples, the investigation may help determine the vulnerabilities that allowed the threat to access the client device. For example, the action can identify outdated software, misconfigurations, or other weaknesses in the network infrastructure, suggest updating patches or security tools, changing access credentials, or other actions in response to the threat.

In some examples, the action may include updating an application programming interface (API), dashboard, or other display. Various examples of the API, dashboard, or display are provided with FIGS. 8-11.

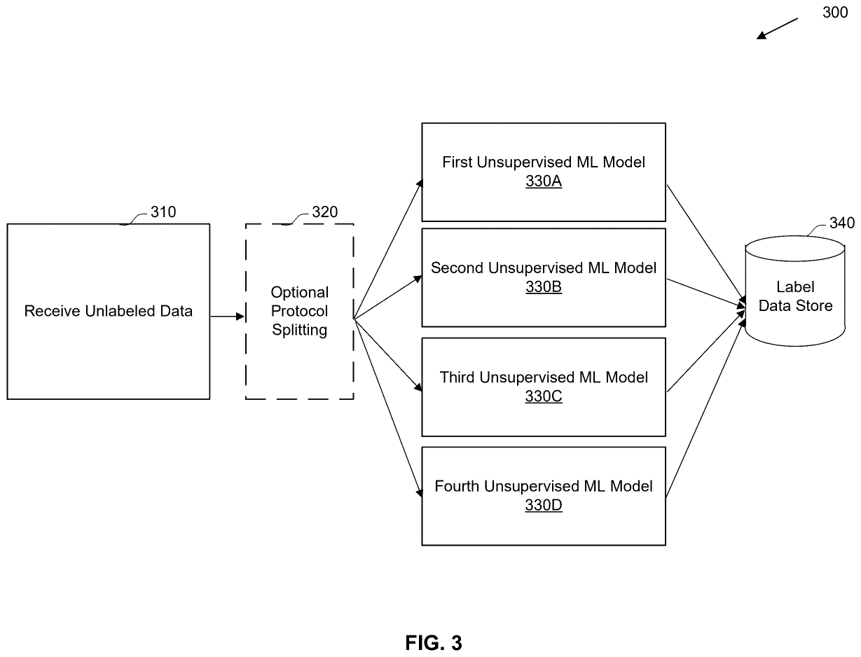

FIG. 3 is an illustrative process of unsupervised machine learning model for generating labeled training data for a supervised machine learning model, in accordance with some of the embodiments disclosed herein. In example 300, detection system 102 illustrated in FIG. 1 may execute machine-readable instructions to perform the operations described herein.

At block 310, the unsupervised machine learning model may receive unlabeled data from the client device, as described herein.

At block 320, the system may parse and normalize network data formats (e.g., flow records, logs, authentication events) and optionally partition by protocol, source, or asset class to route data to appropriate unsupervised learners. This normalization aligns feature scales and schemas used during training.

In some examples, the unlabeled data may be associated with a predefined codec in order to associate the unlabeled data with a particular unsupervised machine learning model. In other examples, the data label may correspond with the codec or other data characteristic. One or more unsupervised machine learning models may be trained and stored for each type of codec or label.

At block 330, various unsupervised machine learning processes or library calls that implement various unsupervised machine learning models may be stored and used to determine the data label for the unlabeled data. For simplicity, the term “unsupervised machine learning model” here refers to the processes or library or API calls implementing the unsupervised machine learning codecs. The determination of the particular unsupervised machine learning model may be matched with the codec (e.g., when the data is telemetry data) or other data characteristic. In this illustration, a set of unsupervised machine learning models are stored in model data store, including a first unsupervised machine learning model 330A, second unsupervised machine learning model 330B, third unsupervised machine learning model 330C, and fourth unsupervised machine learning model 330D.

In some examples, the unsupervised machine learning model may determine whether the data is normal data or outlier data. In determining the normal data and the outlier data, the unsupervised machine learning model may compare a set of data characteristics of normal data to the new, unlabeled data. At a first time, a first label of a set of labels may be assigned to the unlabeled data using an unsupervised machine learning model. This may correspond with normal data that is identified in a first set of unlabeled data. At a second time, second unlabeled data may be received. The second unlabeled data may be provided to a particular unsupervised machine learning model based on a data characteristic. When the data characteristic exists and is assigned to an existing unsupervised machine learning model, the particular unsupervised machine learning model may be selected to assign the label to the unlabeled data. The label may correspond with the first label of the set of labels that was assigned to the first labeled data. In this example, the same label may be assigned to the second unlabeled data because the unlabeled data may be similar to the first unlabeled data based on the set of data characteristics. This may also correspond with normal data that is identified in a second set of unlabeled data. When the data is not similar to the first unlabeled data or any corresponding data characteristics of the first unlabeled data, a new label may be generated and assigned to the second set of labeled data. The new label may be stored with the set of labels and correspond to a second set of the second unlabeled data that is not similar to the first unlabeled data based on the set of data characteristics. This applies to the scenarios where more than two labels are needed. For example, instead of just “normal” and “anomaly,” there might be situations requiring labels like “low risk,” “medium risk,” and “high risk,” or labels like “benign,” “phishing attack,” and “DDoS attack.”

In some examples, the unsupervised machine learning model may correspond with clustering (e.g., k-means, hierarchical clustering), dimensionality reduction (e.g., PCA, t-SNE), association rule learning, or other unsupervised machine learning models. When clustering is implemented, the process may identify natural groupings or clusters in the data, based on a data characteristic, and generate a label associated with that characteristic. When dimensionality reduction is implemented, the process may reduce the number of input variables or features under consideration to simplify the complexity of the dataset by transforming it into a lower-dimensional space while preserving important information. When association rule learning is implemented, the process aims to discover relationships, patterns, or associations within the unlabeled data, and generate a label for the corresponding data. In any of these instances, the unsupervised machine learning model may generate or assign a label that corresponds with “1” for outlier data and “0” for normal data.

The unsupervised machine learning models may be trained on unlabeled data to assign or generate a label for the unlabeled data. The unlabeled data may be received without labeled outputs or target variables. In an illustrative example, the label may correspond with “1” (e.g., normal data) or “0” (e.g., outlier data) based on the characteristics of the data. In another example, the label may correspond with multiple values, including a value associated with one or more data characteristics (e.g., non-binary label).

In some examples, the unsupervised machine learning model may identify new data types that are included with the unlabeled data from the client device. When new data is identified (e.g., when the characteristics of the data do not match pre-existing data characteristics that are previously assigned to labels), a new label may be generated and assigned to the unlabeled data.

In some examples, the unsupervised machine learning model may determine a new label associated with outliers in the data. The outlier may correspond with data that is not similar to previously identified activities in the system, including non-fraudulent or fraudulent activities, and a label corresponding with the outlier may be generated and assigned to the data.

In some examples, the determination of the particular unsupervised machine learning model may use an ensemble of models by including first unsupervised machine learning model 330A, second unsupervised machine learning model 330B, third unsupervised machine learning model 330C, and fourth unsupervised machine learning model 330D. Each of unsupervised machine learning models 330 may correspond with an ensemble of models. For example, when an anomaly detection ensemble is implemented, the unsupervised machine learning model may combine multiple anomaly detection algorithms or use different strategies to detect outliers in data. A data characteristic identified by the unsupervised machine learning model can be used as the data label. In some examples, ensemble and voting are implemented to generate and assign the labels.

At block 340, the label determined by the unsupervised machine learning model may be stored in a label data store. The data may comprise a set of labels and a set of characteristics associated with the unlabeled data.

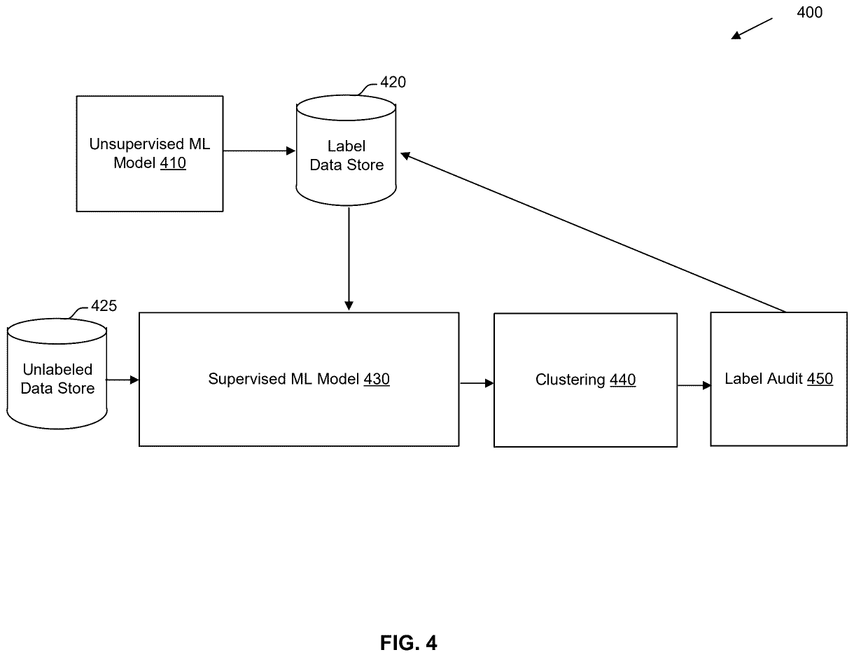

FIG. 4 is an illustrative inference process using a supervised machine learning model, in accordance with some of the embodiments disclosed herein. In example 400, detection system 102 illustrated in FIG. 1 may execute machine-readable instructions to perform the operations described herein. In some examples, the unsupervised machine learning model may be trained to determined labels for unlabeled data from the client device, as described herein.

At block 410, the unsupervised machine learning model generates a set of labels for a plurality of obtained raw data (i.e., unlabeled data). The labels may represent normal data and outlier data. For example, the label may correspond with “1” for outlier data and “0” for normal data.

At block 420, the labels determined during the unsupervised training process may be stored in label data store. The labels may be accessed and used for training the supervised machine learning model to cluster/group data (block 430) and/or may be updated by the label audit process (block 450).

At block 430, the supervised machine learning model may receive new data (e.g., network flow, host telemetry, network topology, log files) from the data repository/data store at block 425 as input during an inference process. When the data are received, the supervised machine learning model may extract features from the new data and classify the data based on the distances between the extracted features and the features of the clusters or groups learned during the training process. This classification process assigns the appropriate label to each new data point, identifying whether the behavior represented by the data is consistent with an existing cluster or indicative of an anomaly. The labeled outputs are then provided to block 440, where related events can be clustered and further analyzed.

In some examples, an ensemble of supervised machine learning models is implemented, which combines multiple models. For example, the supervised machine learning model may implement a Random Forest ensemble method that includes multiple instances of the same learning algorithm on different subsets of the training data to build diverse models. In another example, the supervised machine learning model may implement a voting process that includes combining predictions from multiple models and selecting the final output based on majority voting or a weighted averaging of individual model predictions.

At block 440, similar events identified in the new data (which has been assigned a label by the supervised machine learning model) may be clustered during the inference process. For example, the events that are associated with the first label that existed in the label data store may be considered normal data, whereas events associated with a second label that does not exist in the label data store may be considered outlier or anomalous data. The clustering results may be written to the persistence layer together with corresponding node identifiers in the dynamic network graph, enabling the system to update cluster assignments and trigger alerts or security actions when anomalies exceed defined policy thresholds.

At block 450, a label audit process may update the cluster/output of the supervised machine learning model. During the label auditing process, the data associated with the particular label may be evaluated for similarity. The data entries assigned the same label but having a distance that is greater than a predetermined similarity threshold may be flagged for further review. The labels may be revised or added by human or automated input. In some examples, the data are provided to a display or real-time API to receive an interaction from the user to help relabel the clustered data.

The revised or added labels may be added back to the label data store (block 420) to initiate a second training process of the supervised machine learning model (block 430). The second training process may combine the labels generated/assigned from the unsupervised machine learning model and the label auditing process to generate an improved supervised machine learning model (block 430). The improved supervised machine learning model may be retrieved from the model data store and executed on new data during a future inference process of the new data.

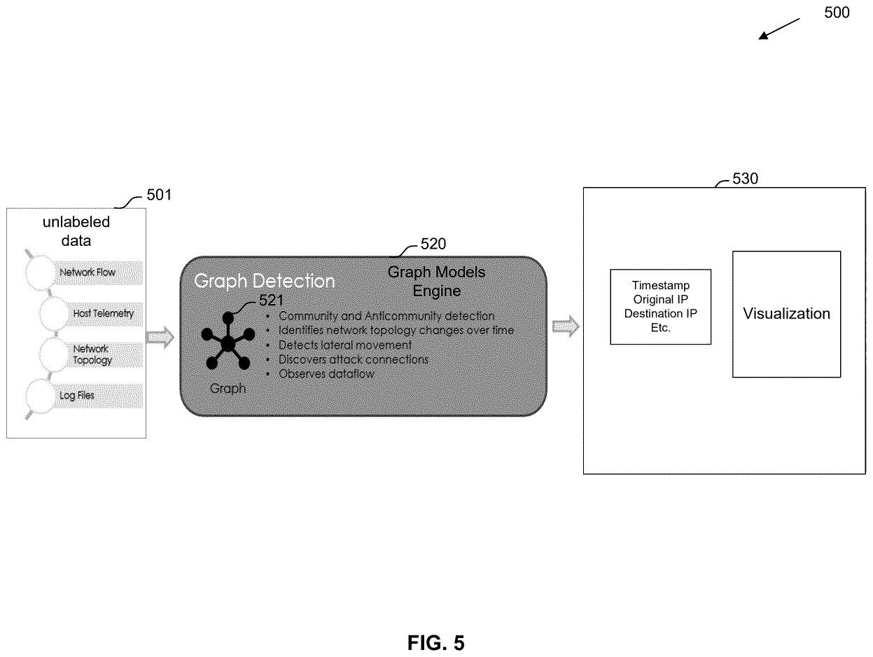

FIG. 5 is an example 500 configuration of a graph models engine 520, which conceptually illustrates the engine's 520 functions and capabilities within the detection system 102. The graph models engine 520 is configured to implement various graph anomaly detection features for cybersecurity, which includes the analysis and monitoring of network traffic and system activities represented as graphs. The graph models engine 520 may operate on the dynamic network graph (e.g., maintained by pre-processing).

As depicted in FIG. 5, the graph models engine 520 can receive unlabeled data 501 as input. The unlabeled data 501 can be information that is pertinent to analysis and detection of cybersecurity threats including, but not limited to: network flow; host telemetry; network topology; and log files. By receiving the unlabeled data 501 as inputs, the graph models engine 520 can generate graphs 521 representing monitored networks. The graphs 521 can be used to model the relationships and dependencies between various entities, such as devices, users, and applications in a network. By analyzing the patterns and anomalies within these graphs, the graph models engine 520 can ultimately detected, pinpoint the source, and predict the spread of suspicious and/or malicious activities within the network. For example, in a graph 521 generated by the graph models engine 520, nodes can represent devices or users, and edges can represent connections or interactions between them. Thus, by analyzing the graph 521 and applying graph anomaly detection techniques, unusual patterns, such as sudden spikes in data transfers or unexpected connections can be identified in the graph 521 which might indicate a potential security threat. The graph models engine 520 identifies anomalous nodes by determining when a node's behavior characteristics are inconsistent with characteristics of the node's assigned cluster within the dynamic network graph, thereby detecting threats that preserve superficial connectivity patterns while deviating in higher-dimensional behaviors.

The graph models engine 520 leverages the generated graphs 521 in order to implement various graph anomaly detection capabilities, which help identify anomalies and enhance the ability to detect and response to cybersecurity incidents. FIG. 5 illustrates that the graph models engine 520 is configured to execute several graph anomaly detection functions that include: community and anticommunity detection; identification of network topology changes over time; lateral movement detection; attack connection discovery; and dataflow observation.

Additionally, FIG. 5 illustrates an example graphical user interface (GUI) display that can be generated as a function of the graph models engine 520, in accordance with some of the embodiments disclosed herein. As an example, the graph models engine 520 can generate and output a display 530 which is illustrated in FIG. 5 as a rendered visualization of a graph and related information (e.g., timestamp, origin IP, destination IP, etc.). The graph models engine 520 can output display 530 in association with automated threat detection. In some examples, detection system 102 illustrated in FIG. 1 may execute machine-readable instructions to generate the display 530. According to the embodiments, the graph models engine 520 performs graph anomaly detection with high speed and accuracy, by looking at the structure of the communities within the graph 521 of a network to find complex threats and vulnerabilities. The graph models engine 520 also executes enhanced functions such as identifying the origin (e.g., source) of threats, and predicting what other connected nodes could be infiltrated next by the threat in order to aid with detecting a cyber-attack (e.g., in progress) and accelerating the threat remediation process.

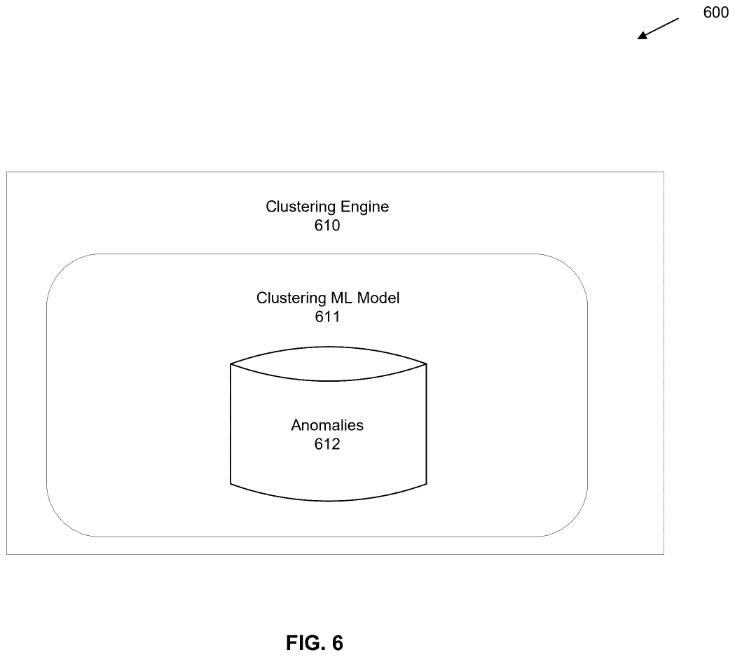

FIG. 6 is an example 600 configuration of a clustering engine 610 (e.g., clustering engine 118), which conceptually illustrates its functions and capabilities within the detection system 102. Clustering engine 610 is configured to implement various clustering features that may be pertinent to anomaly and/or threat detection in cybersecurity, which includes anomaly clustering. The clustering engine 610 can execute anomaly clustering that involves grouping together similar anomalies 612, for example grouping detected anomalies 612 into coherent clusters of anomaly types. The anomalies 612 are depicted as data, such as labels or information related to anomalies, security incidents, and/or abnormal network activities that have be detected in a monitored network and thereafter stored within a data store. The clustering engine 610 can organize and/or categorize anomalies 612, which enables a more systematic and insightful approach to understanding and addressing security threats.

FIG. 6 illustrates that the clustering engine 610 can include a clustering ML model 611 that leverages inference to group similar data points, namely anomalies 612, together based on certain features and characteristics. In some examples, the clustering ML model 611 is trained to identify natural patterns or structures within the anomalies 612 data with or without predefined labels. In order words, the clustering ML model 611 can execute anomaly clustering as an unsupervised learning approach or a supervised learning approach, where algorithms discover inherent structures and patterns in the anomalies 612 data on its own, or alternatively leverages labels associated with anomalies 612 data during training. By intelligently and efficiently clustering anomalies 612, the clustering engine 610 can identify recurring patterns or attack strategies, which realizes several advantages for the detection system 102 such as enabling faster correlation of related anomalies and more efficient allocation of computational resources.

The clustering engine 610 may employ a QUBO-based clustering model to assign nodes to clusters within the dynamic network graph and to identify anomalies based on deviations from cluster characteristics. The clustering engine 610 may use the QUBO model to cluster nodes of the dynamic network graph and to identify clusters exhibiting abnormal composition or boundary changes. In certain embodiments, the clustering engine 610 clusters the nodes of the dynamic network graph by solving a QUBO formulation whose objective encodes clustering based on the behavior characteristics, to obtain cluster assignments for the nodes.

In some embodiments, the clustering engine 610 supports fast, density-based clustering (e.g., DBSCAN, HDBSCAN) and centroid-based clustering (e.g., k-means) over the behavior characteristics to produce cluster assignments with low latency during inference.

In other embodiments, or as a complementary step, clustering engine 118 clusters the nodes by solving a QUBO formulation whose objective encodes clustering based on the behavior characteristics. In a two-stage mode, the engine may first apply a fast clustering algorithm to obtain high-quality initial clusters and then invoke a QUBO-based label-auditing validator to evaluate cluster quality and refine boundary assignments. This hybrid strategy provides fast online clustering and periodic or triggered QUBO audits that can, for example, produce an optimal clustering under a clique-partition objective, improving stability and accuracy without incurring full recomputation on every update.

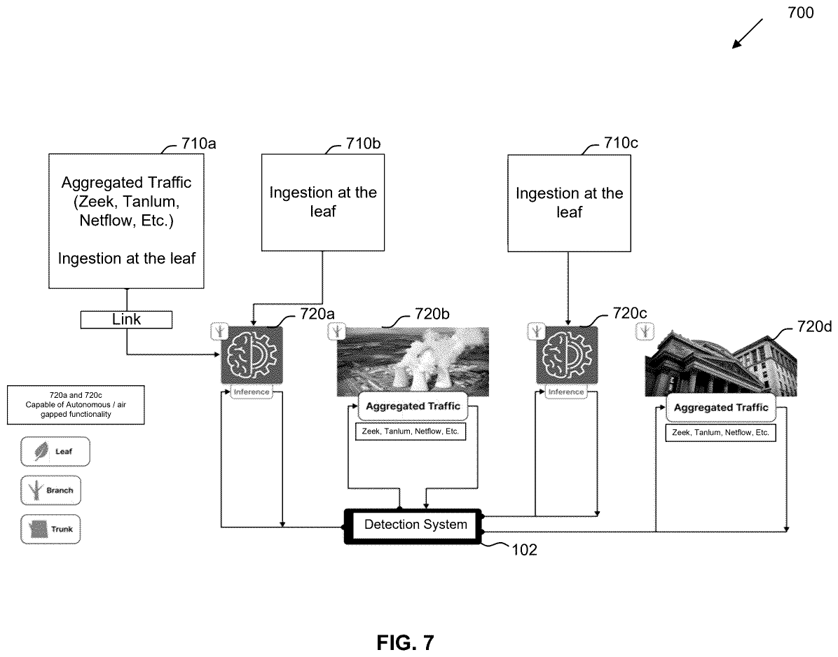

FIG. 7 depicts an example network environment 700, which includes a scalable configuration for implementing the detection system 102 and capabilities, as disclosed herein. A key feature of detection system 102 is scalability of its functions and elements, as illustrated in FIG. 7, which is crucial because threats are constantly evolving, and organizations need systems that can grow and adapt to new challenges without compromising protection. In the example of FIG. 7, the detection system 102 is a scalable cybersecurity system that has several elements that are communicatively distributed within the networking environment 700. In particular, FIG. 7 illustrates that the networking environment 700 comprises the scalable configuration having several distributed entities including leaves 710a-710c, branches 720a-720d, and the detection system 120, which serves as the trunk. Accordingly, the detection system 102 can be scaled in a manner that can be adapted and expanded to effectively protect an organization's information and assets as its needs and challenges evolve.

Significant characteristics of scaling with respect to operation of the detection system 102 include, but are not limited to: 1) reduced latency at scale, which eliminates the need for transmitting data to the trunk for processing, which can be time-consuming and lead to delays; 2) lower network bandwidth, which reduces the amount of data to be transmitted to the trunk, reducing network bandwidth costs and increasing performance; 3) improved reliability, where branch and leaf edge systems can continue to operate even when there is no connection to the hub; 4) cost-effectiveness, which reduces cost of trunk computing resources and data transfers, as well as improves the efficiency of the overall system; and 5) extensibility, which dramatically increases data processing bandwidth with a smaller hardware footprint.

FIG. 7 illustrates an example of the detection system 102 in a scalable configuration, where the elements included therein are arranged in a generally hierarchical structure. As seen in FIG. 7, the hierarchy includes the several leaves 710a-710c distributed at the edge, branches 720a-720d as the intermediary elements, and the trunk (e.g., detection system 102 hardware) at the hub. As the trunk, the detection system 102 is a core component that can coordinate and oversee the entire system. Further, the detection system 102 can manage the overall flow of information, direct traffic between branches 720a-720d and maintain the system's integrity and scalability. The scalable configuration also comprises several distributed branches 720a-720d, where the branches 720a-720d act as the intermediate components that manage and distribute tasks. For example, FIG. 7 illustrates that 720a-720d can perform specific tasks such as aggregating data (e.g., collected at leaves 710a-710c) and executing machine learning related functions (e.g., models, inferences, etc.). The branches 720a-720d can help achieve load balancing and ensuring efficient utilization of resources. Additionally, scaling can includes having leaves 710a-710c that are arranged at the edge of the distributed configuration. The leaves 710a-710c are the individual nodes, endpoints, or edge systems that directly interact with users or external systems, for instance running applications that ultimately perform threat and vulnerability detection and/or other related cybersecurity functions. The leaves 710a-710c can perform specific tasks, such as ingestion (e.g., data collection), and communicate with the branches 720a-720d.

By supporting scaling, the detection system 102 can realize the wide-range of advantages associated with scalability and provide features that are related to scalable cybersecurity systems, such as elasticity (e.g., dynamic allocation of resources based on demand); automation; centralized management; modularity; scalable threat intelligence; and cloud-based solutions.

FIG. 8 is an example threat detection display, in accordance with some of the embodiments disclosed herein. In example 800, a display is illustrated with a data timeline and potential outlier data in association with automated threat detection. In some examples, detection system 102 illustrated in FIG. 1 may execute machine-readable instructions to generate the display.

At block 810, a data timeline is provided, which illustrates an amount of unlabeled data received from the client device and spikes in the data when outlier events may be identified. The timeline may be adjusted in time increments (e.g., 15 minutes, 1 hour, etc.) to illustrate the amount of data received from the client device by the detection system.

At block 820, a number of anomalies detected is provided in a numerical value format. The number of anomalies may correspond with a second label of the set of labels determined by the unsupervised machine learning model.

At block 830, a data label is provided at the display. The data label corresponds with the IP address or host name associated with the data packet. Each new instance of the data label that is included in the new data is repeated on the display as it is received from the client device. In this instance, the data label is repeated four times (blocks 830A, 830B, 830C, 830D).

At block 840, the confidence score is provided. In this example, the confidence score may correspond with the determination that the unlabeled data is outlier data. In other words, the unlabeled data corresponds with data that is previously unlabeled and not similar to other previously labeled data in the system. A correlation may exist between the confidence score and the determination of outlier data, including an instance when the data is not similar to existing data, a subsequent action is recommended to be performed (e.g., to remedy a potential threat).

The confidence scores may be assigned to different colors in accordance with the likelihood that the data received from the client device are outlier data. For example, the data corresponding with a high likelihood that the data are an outlier (e.g., the data are not similar to a preexisting label) may correspond with the color red, the data corresponding with a medium likelihood that the data are an outlier may correspond with the color yellow, and the data corresponding with a low likelihood that the data are an outlier (e.g., the data are somewhat similar to a preexisting label) may correspond with the color green.

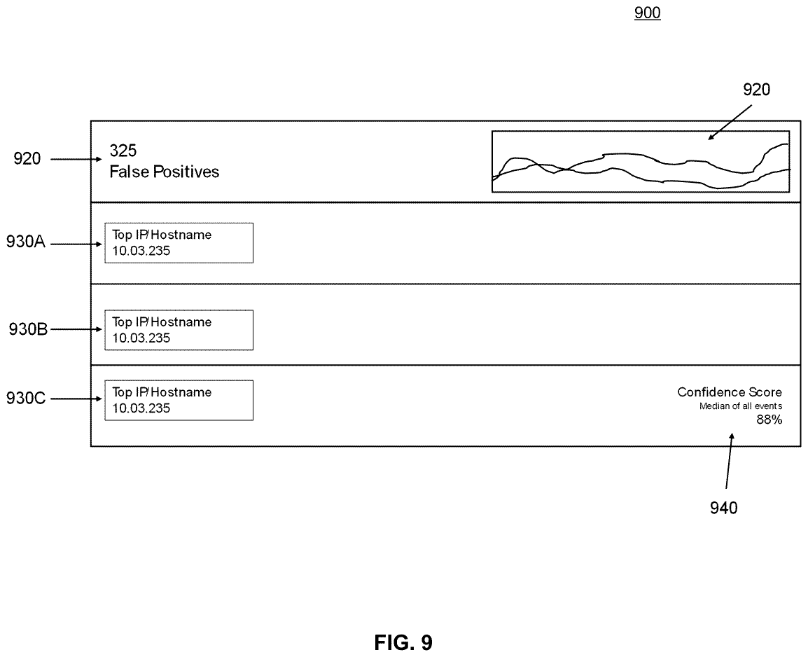

FIG. 9 is an example threat detection display, in accordance with some of the embodiments disclosed herein. In example 900, a display is illustrated with a relabeling queue associated with a label audit process and potential outlier data in association with automated threat detection. In some examples, detection system 102 illustrated in FIG. 1 may execute machine-readable instructions to generate the display.

At block 910, a relabeling queue timeline is provided. In the relabeling queue timeline, true anomalies and false positive anomalies are provided in a chart with respect to the time each data are received during a measured time period.

At block 920, a number of anomalies detected is provided in a numerical value format. The number of anomalies may correspond with a second label of the set of labels determined by the unsupervised machine learning model.

At block 930, a data label is provided at the display. The data label corresponds with the IP address or host name associated with the data packet. Each new instance of the data label that is included in the new data is repeated on the display as it is received from the client device. In this instance, the data label is repeated three times (blocks 930A, 930B, 930C). In this example, the identification of whether the data is a true anomaly or a false positive anomaly are provided as well. The data may be confirmed as an anomaly and correspond with a data characteristic that is not previously identified and labeled by the system.

At block 940, the confidence score is provided. The confidence score in this example is similar to the confidence score provided in FIG. 8 and repeated herein.

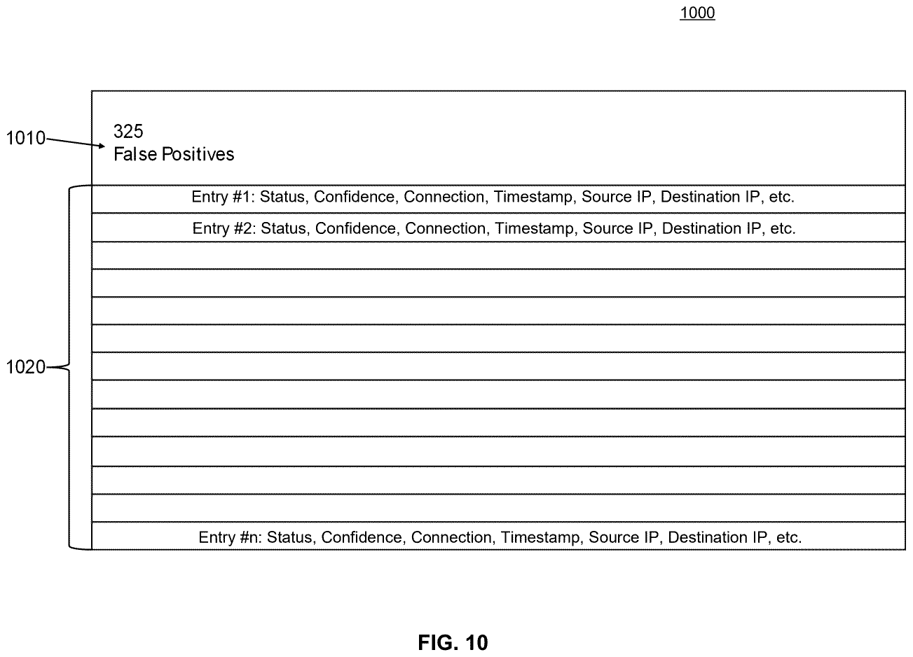

FIG. 10 is an example threat detection display, in accordance with some of the embodiments disclosed herein. In example 1000, a display is illustrated with a relabeling queue associated with a label audit process and potential outlier data in association with automated threat detection. In some examples, detection system 102 illustrated in FIG. 1 may execute machine-readable instructions to generate the display.

At block 1010, a number of anomalies detected is provided in a numerical value format. The number of anomalies may correspond with a second label of the set of labels determined by the unsupervised machine learning model.

At block 1020, individual entries of the relabeling queue are provided. Additional data provided in association with the data label that is not similar to previously assigned data labels is also provided. For example, additional data may include a status (processed or not processed), confidence score (with red/yellow/green label), timestamp that the data was received from the client device, criticality, source IP address (identifying a client device).

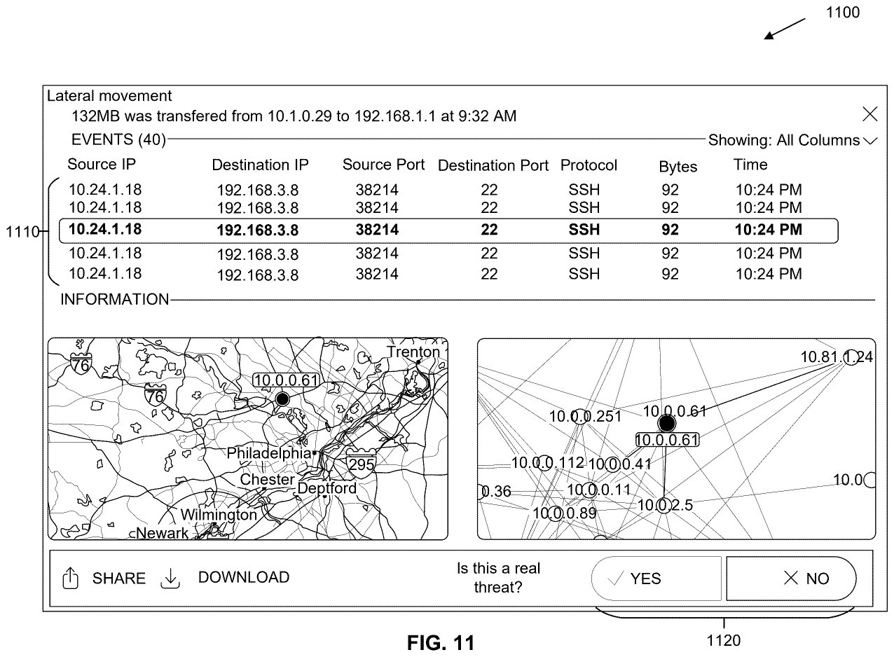

FIG. 11 is an example threat detection display, in accordance with some of the embodiments disclosed herein. In example 1100, a display is illustrated to show the location of the client device and label that potentially corresponds with outlier data. In some examples, detection system 102 illustrated in FIG. 1 may execute machine-readable instructions to generate the display.

At block 1110, the individual entries of the relabeling queue are provided. Additional data provided in association with the data label that is not similar to previously assigned data labels is also provided. For example, additional data may include a source IP address, destination IP address, source port, destination port, protocol (e.g., SSH), bytes of data, and timestamp that the data was received from the client device.

At block 1120, the display may provide an interaction tool during the label audit process. During the label auditing process, the display may allow an interaction with the individual label. When an interaction is received (e.g., “yes, this data is properly labeled” or “yes, this data corresponds with a threat”), the process may use the interaction response to revise labels associated with particular data or data characteristics. In some examples, the interaction response is received from a human user and the updated label is provided to retrain the supervised machine learning model.

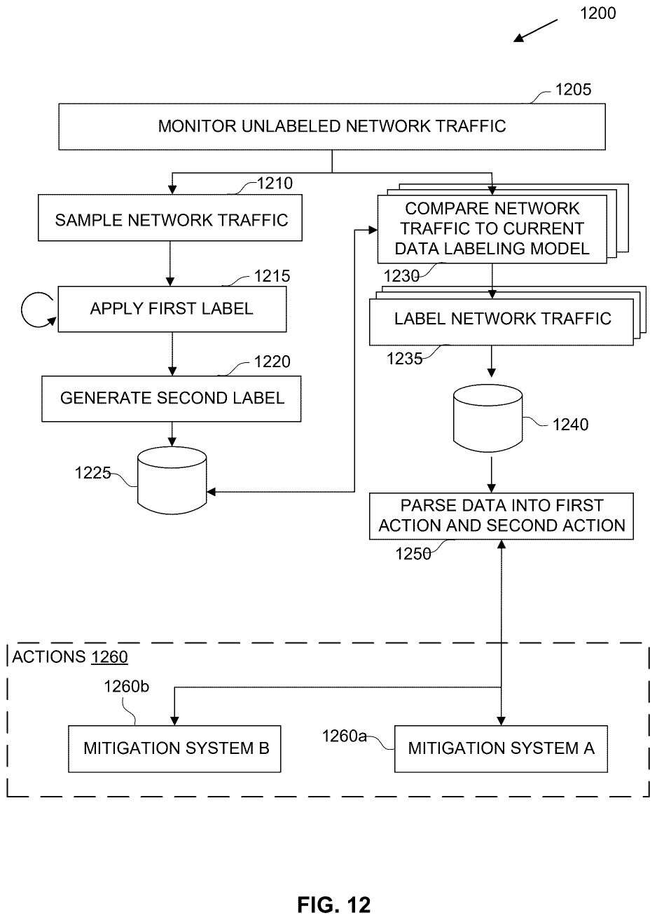

FIG. 12 illustrates a computer method and database connections for monitoring network threats, according to an embodiment. In example 1200, In some examples, detection system 102 illustrated in FIG. 1 may execute machine-readable instructions to perform the operations described herein.

At block 1205, unlabeled data is monitored in network traffic communications transmitted across the computer network. The process may proceed to block 1210 or block 1230.

At block 1210, a portion of the computer network data transmissions may be received and sampled by detection system 102 of FIG. 1. Receiving the portion of computer network data transmissions may include sampling the unlabeled network traffic communications. The sampling may include less than the entirety of computer network data transmissions. The computer network data transmissions may be characterized by metadata. In some examples, the training portion may introduce latency into the sampled data transmissions. The sampling, or using less than the entirety of the data, may allow the network as a whole to provide low latency data communications by bypassing the training portion of the method. The process may proceed to block 1215.

At block 1215, a first label may be applied. The first label may be similar to a label assigned to previously-received data, which identifies that the data are similar or comprise similar data characteristics. In some examples, labeling may be derived. For example, a threat labeling model as a function of data transmission parameters to produce a data labeling model. Block 2 1215 may be included in a portion of the process 1200 characterized as “training”.

In some examples, deriving the threat labeling model as a function of data transmission parameters is performed without human supervision and may be performed continuously. In some examples, performing the comparison of the computer network data transmissions to the transmission labeling model is performed at least partly by a quantum or quantum-inspired computer.

In some examples, deriving the threat labeling model as a function of data transmission parameters to produce a data labeling model may include comparing the data transmissions to previously labeled data transmissions, and identifying data transmission metadata that match attributes of the previously labeled data transmissions. For example, the previously labeled data transmissions may include data transmissions previously characterized as Denial of Service (DOS), Remote to User (R2L), User to Root (U2R), and Probing (Probe).

The labels may be updated in label data store 1225. Updating the data transmission labeling model 1225 to create a current data transmission labeling model. The process may proceed to block 1230.

At block 1230, network traffic may be compared to the data labeling model. The network traffic may comprise the computer network data transmissions, which can be compared to the data transmission labeling model.

Labeling, with the second server computer, the computer network data transmissions corresponding to the data labeling model in step 1235 may be performed as a function of the comparison of the computer network data transmissions to the data transmission labeling model performed in step 1230.

In some examples, performing the comparison of the computer network data transmissions to the transmission labeling model in step 1230 is performed at least partly by a quantum or quantum-inspired computer.

Comparing the computer network data transmissions to the data transmission labeling model, in step 1230, may be performed on all or a majority of computer network data transmissions. This is in contrast to generating the data labeling model, in step 1215, being performed using a sample of the computer network data transmissions.

At block 1235, a second server computer labels computer network traffic corresponding to the data labeling model to produce a population of threat-labeled computer network traffic.

The threat-labeled computer network traffic may be stored in network traffic data store 1240 carried by a non-transitory computer readable medium. Block 1235 may be included in a portion of the process 1200 characterized as “inference”. The process may proceed to block 1250.

In some examples, the process comprises displaying on an electronic display, with the server computer, a graphical user interface for presentation to a user (not shown) and receiving, from the user via the graphical user interface, a command to derive the threat labeling model (not shown). The method 1200 may further include deriving, with the server computer or the second server computer, a representation of threat identification outcome; and displaying on the electronic display, with the server computer or the second server computer, the representation of threat identification outcome.

In some examples, labeling the computer network traffic corresponding to the data labeling model (using label data store 1225) to produce the population of threat-labeled computer network traffic (using network traffic data store 1240) includes performing a plurality of processes with a quantum or quantum-inspired computer.

In some examples, labeling the computer network traffic corresponding to the data labeling model (using label data store 1225) to produce the population of threat-labeled computer network traffic (using network traffic data store 1240) includes converting the data corresponding to unlabeled computer network traffic to a quadratic unconstrained binary optimization (QUBO) problem with a solver program running on the second server computer. The QUBO problem may be served to the quantum or quantum-inspired computer a plurality of times by the solver program. The solver program may combine a plurality of QUBO solutions received from the quantum or quantum-inspired computer to label the computer network traffic. The data labeling model may be converted to one or more QUBO penalty functions by the solver program.

At block 1250, threat-labeled network traffic may be parsed into a first action and a second action. Once the data are parsed, the respective sub-populations of threat-labeled network data transmissions may be provided to initiate one or more actions 1260. The actions may correspond with transmitting alerts/notifications to various threat mitigation systems (illustrated as first mitigation system 1260a and second mitigation system 1260b) or initiating remote processing at these systems. The parsing process may deliver respective sub-populations of threat-labeled network data transmissions to the one or more threat mitigation systems 1260a, 1260b.

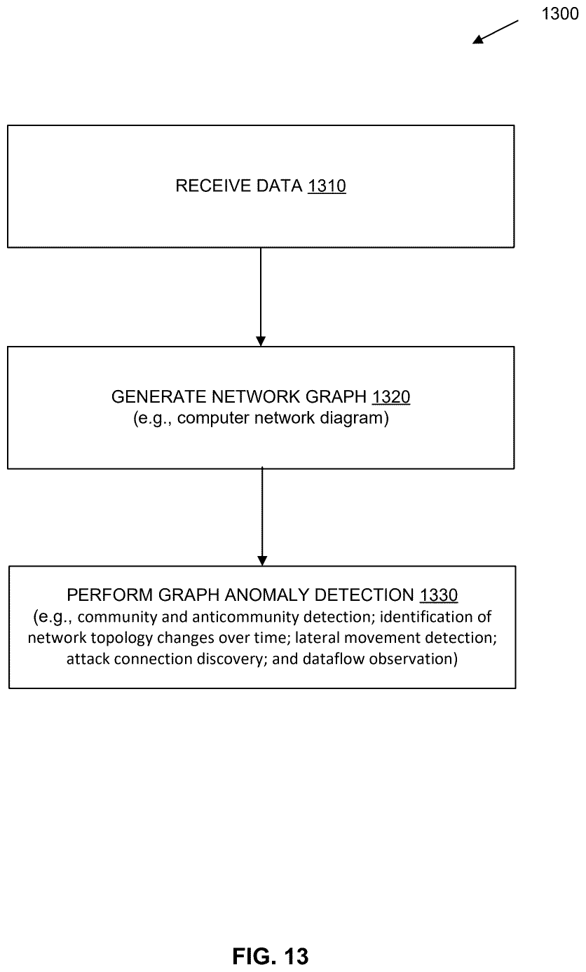

FIG. 13 is a process for performing graph anomaly detection, in accordance with some of the embodiments disclosed herein. In example 1300, detection system 102 illustrated in FIG. 1 may execute machine-readable instructions to perform the operations described herein.

At block 1310, the method involves receiving data as input for further analysis. In some implementations, the data received in block 1310 is unlabeled data or information that is pertinent to analysis and detection of cybersecurity threats including, but not limited to: network flow; host telemetry; network topology; and log files.

At block 1320, the method generates graphs. By receiving the data as inputs (at previous block 1310), one or more graphs representing a monitored network, for example, can be generated at block 1320. The graph can be generated as a computer networking diagram, which is a schematic depicting the network in a manner that models the relationships and dependencies between various entities, such as devices, users, and applications in the network. For example, a graph generated at block 1320 can include nodes in the graph that represent devices or users, and edges in the graph that can represent connections or interactions between the aforementioned nodes. By analyzing the patterns and anomalies within these graphs, the method ultimately detects threats and predicts the potential spread of the threat within the network.

At block 1330, the method leverages the generated graphs (at previous block 1320) in order to perform various graph anomaly detection functions. The graph anomaly detection at block 1330 identifies anomalies and enhances the ability to detect and response to cybersecurity incidents. Block 1330 can involve performing several graph anomaly detection functions that include: community and anticommunity detection; identification of network topology changes over time; lateral movement detection; attack connection discovery; and dataflow observation. For example, block 1330 a graph is analyzed in order to identify unusual patterns, such as sudden spikes in data transfers or unexpected connections in the graph, which might indicate the detection of a potential security threat in graph anomaly detection. In some implementations, block 1330 can involve generating GUI associated with graph anomaly detection. For example, a display can be generated which renders a visualization of a network graph and related information (e.g., timestamp, origin IP, destination IP, etc.). According to the embodiments, the method performs graph anomaly detection with high speed and accuracy, by looking at the structure of the communities within graphs of a network to find complex threats and vulnerabilities. The method also executes enhanced functions such as identifying the origin (e.g., source) of threats, and predicting what other connected nodes could be infiltrated next by the threat in order to aid with detecting a cyber-attack (e.g., in progress) and accelerating the threat remediation process.

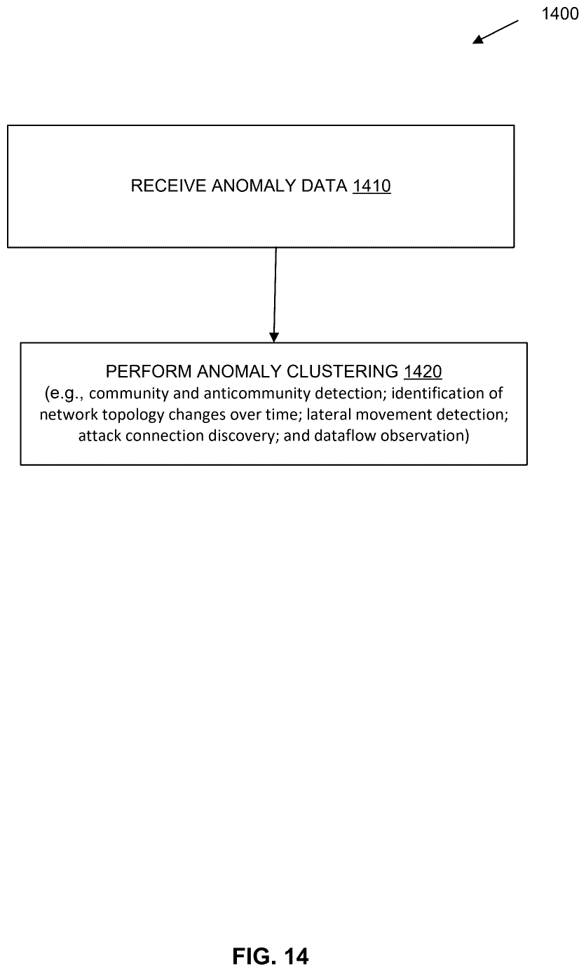

FIG. 14 is a process for performing anomaly clustering in dynamic network environments, in accordance with some of the embodiments disclosed herein. In example 1400, detection system 102 illustrated in FIG. 1 may execute machine-readable instructions to perform the operations described herein. FIG. 14 illustrates dynamic graph anomaly detection, in which connections between devices change over time. The system maintains a dynamic network graph, clusters nodes using a QUBO model, and detects anomalies from deviations between a node's behavior characteristics and those of its assigned cluster. When new network data indicates topology changes, the clustering may be incrementally updated without full recomputation, enabling faster and more consistent detection.

The method is configured to implement various clustering features that may be pertinent to anomaly and/or threat detection in cybersecurity, which includes anomaly clustering.

At block 1410, anomaly data is received. The anomaly data may be associated with anomalies detected in a monitored network where connections between devices change dynamically over time. For example, anomaly data can be received by accessing a data store, where anomaly data can be stored with labels or information related to anomalies, security incidents, and/or abnormal network activities detected in a network. In some implementations, anomaly data includes predefined labels. Alternatively or additionally, the anomaly data may be associated with anomalies detected in a monitored network where connections between devices change dynamically over time.

At block 1420, the anomaly data is analyzed in order to perform anomaly clustering and detection. Anomaly clustering and detection at block 1420 can involve organizing and/or categorizing anomalies that have been detected, which enables a more systematic and insightful approach to understanding and addressing security threats. For example, anomaly clustering and detection can be executed by grouping together similar anomalies into coherent clusters of anomaly types.

In some implementations, block 1420 includes implementing a clustering ML model that leverages inference to group similar anomalies together based on certain features and characteristics. In some examples, the clustering ML model executes anomaly clustering using an unsupervised learning approach. The clustering ML model can discover inherent structures and patterns in the anomaly data, and subsequently can cluster them together based on similarities in the recognized patterns. By intelligently and efficiently clustering anomalies, the method can identify recurring patterns or attack strategies, which realizes several advantages for the detection system 102 such as enabling faster correlation of related anomalies and more efficient allocation of computational resources.

Alternatively or additionally, block 1420 may include dynamic anomaly clustering using optimization algorithms. This may involve analyzing the anomaly data to group together similar anomalies or unusual patterns within the dynamically changing network graph. In one embodiment, block 1420 implements a QUBO optimization model to perform community detection (clustering) that adapts to the evolving network topology. The optimization algorithm may recalculate cluster assignments as network connections between devices shift, ensuring that anomaly detection remains accurate in the dynamic graph environment.

The dynamic anomaly clustering may group together similar anomalies into coherent clusters (communities) based on behavioral characteristics that account for the temporal changes in device connectivity. The process leverages fast clustering algorithms specifically designed for dynamic graphs, where the QUBO optimization model continuously updates community boundaries as network relationships evolve. When significant topology changes are detected, the system can incrementally update cluster assignments without requiring full recomputation of all clusters. In certain embodiments, the system clusters nodes by solving a QUBO formulation whose objective encodes clustering based on the behavior characteristics, and the solution yields cluster assignments for the nodes in the dynamic network graph.

The clustering process may utilize quantum or quantum-inspired computers to solve the QUBO optimization problems efficiently, enabling real-time adaptation to changing network conditions. That is, the process may refresh behavior characteristics over successive time intervals and incrementally update cluster assignments when localized topology or feature changes occur. The clustering process may utilize quantum or quantum-inspired computers to solve the QUBO optimization problems efficiently, enabling real-time adaptation to changing network conditions. Accordingly, the process/steps of blocks 1410 and 1420 enables a systematic approach to understanding and addressing security threats in dynamic network environments by identifying recurring patterns or attack strategies that may shift as network topology changes. This dynamic-clustering architecture improves computer performance by reducing redundant recomputation, lowering processing latency, and enabling the detection system to maintain accurate anomaly baselines in real time as network topologies evolve. This approach improves the operation of the computer itself by reducing redundant computations and memory access during cluster updates, thereby decreasing processing latency and resource utilization in large-scale network-monitoring deployments.

In some implementations, clustering is performed in two stages: a fast pass (e.g., DBSCAN, HDBSCAN, or k-means) followed by a QUBO-based label-auditing step that validates cluster quality and, when indicated, reassigns boundary nodes or computes an optimal clique partition. The anomaly-detection stage then operates on the resulting cluster assignments.

In some embodiments, the detection system described herein employs both unsupervised and supervised machine learning models to identify anomalies not just within graphs (the graphs using nodes and connections representing a network) but also within events that occur across the network. An “event” in this context could refer to a specific action or sequence of actions within the network, such as login attempts, file access patterns, data transfers, or network connections.

Consider login attempts across a network. The unsupervised machine learning process might cluster these events based on characteristics such as login time, IP address, and user credentials. Normal login behaviors could be grouped together, while anomalous logins—such as multiple failed attempts from different locations—might form a distinct cluster. The process labels these clusters, identifying normal and potentially suspicious events.

Then a machine learning model might be trained using supervised learning based on labeled data that includes normal login patterns versus suspicious login patterns, such as repeated failed login attempts from different IP addresses or logins from geographically distant locations within a short time frame. The model is trained to recognize these patterns so that it can later infer whether new, unseen login attempts are normal or anomalous.

During the inference phase, the trained supervised model is used to analyze new event data as it arrives. The model applies what it has learned from the training data to detect anomalies in real-time. Imagine a scenario where the system monitors login attempts across a network. The trained model might flag an event where multiple login attempts are made from a previously unseen IP address, or where a login occurs from a location that is unusual for the user, such as a different country or region. If this deviates from the normal login patterns learned during training, it could indicate a potential account compromise or unauthorized access attempt.

Other applications of event anomaly detection may include file access (anomalous file access might include unauthorized attempts to access restricted files, unusual file modification patterns, or large-scale deletion of files), network connections (connections to previously unknown or blacklisted IP addresses, unusual spikes in network traffic, or connections established using uncommon protocols), process execution (anomalous events could include the execution of processes that are rarely or never seen on a particular machine, or the execution of processes that match known malware behavior).

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

The process may be implemented by a computer system. The computer system may include a bus or other communication mechanism for communicating information, one or more hardware processors coupled with the bus for processing information. The hardware processor(s) may be, for example, one or more general purpose microprocessors.

The computer system also includes a main memory, such as a random access memory (RAM), cache and/or other dynamic storage devices, coupled to the bus for storing information and instructions to be executed by the processor. The main memory also may be used for storing temporary variables or other intermediate information during execution of instructions to be executed by the processor. Such instructions, when stored in storage media accessible to the processor, render the computer system into a special-purpose machine that is customized to perform the operations specified in the instructions.

The computer system further includes a read only memory (ROM) or other static storage device coupled to the bus for storing static information and instructions for the processor. A storage device, such as a magnetic disk, optical disk, or thumb drive, may be coupled to the bus for storing information and instructions.

The computer system may be coupled via the bus to a display, such as a liquid crystal display (LCD), for displaying information to a computer user. An input device, including alphanumeric and other keys, is coupled to the bus for communicating information and command selections to the processor. Another type of user input device is a mouse, a trackball, or cursor direction keys for communicating direction information and command selections to the processor and for controlling cursor movement on the display. In some embodiments, the same direction information and command selections as cursor control may be implemented via receiving touches on a touch screen without a cursor.

The computing system may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system may implement the techniques described herein using customized hard-wired logic, one or more ASICs or FPGAs, firmware and/or program logic which in combination with the computer system causes or programs the computer system to be a special-purpose machine. According to one embodiment, the techniques herein are performed by the computer system in response to the processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computer system also includes a communication interface coupled to the bus. The interface provides a two-way data communication coupling to one or more network links that are connected to one or more local networks. For example, the interface may be an integrated services digital network (ISDN) card, cable modem, satellite modem, or a modem to provide a data communication connection to a corresponding type of telephone line. As another example, the interface may be a local area network (LAN) card to provide a data communication connection to a compatible LAN (or WAN component to communicated with a WAN). Wireless links may also be implemented. In any such implementation, the interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network links and through an interface, which carry the digital data to and from the computer system, are example forms of transmission media.

The computer system can send messages and receive data, including program code, through the network(s), network links, and interfaces. In the Internet example, a server might transmit a requested code for an application program through the Internet, the ISP, the local network and the interface. The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (Saas). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
receiving network data describing communications associated with a computer network over successive time intervals;
constructing and maintaining a dynamic network graph based on the network data, the dynamic network graph comprising nodes representing computing entities and edges representing communications among the nodes;
determining, for the nodes, behavior characteristics based at least in part on the dynamic network graph;
clustering the nodes of the dynamic network graph using a clustering algorithm that processes the behavior characteristics to obtain cluster assignments for the nodes; and
detecting anomalies by identifying nodes whose behavior characteristics are inconsistent with characteristics of their respective cluster assignments, and causing an alert or a security action in response.

2. The method of claim 1, further comprising validating or refining the cluster assignments by solving a quadratic unconstrained binary optimization (QUBO) formulation whose objective encodes clustering based on the behavior characteristics, and updating one or more cluster assignments in response to the solution.

3. The method of claim 2, wherein the validating or refining comprises label auditing, the label auditing using the QUBO formulation to judge or validate cluster assignments produced by one or more clustering algorithms.

4. The method of claim 3, wherein label auditing uses the QUBO formulation to evaluate cluster assignments generated by one or more fast clustering algorithms including DBSCAN, HDBSCAN, or k-means, and to adjust the assignments or produce auditing scores indicative of cluster quality.

5. The method of claim 1, wherein the clustering algorithm comprises a density-based clustering algorithm selected from DBSCAN or HDBSCAN.

6. The method of claim 1, wherein the clustering algorithm comprises k-means.

7. The method of claim 1, wherein clustering the nodes comprises solving a quadratic unconstrained binary optimization (QUBO) formulation whose objective encodes clustering based on the behavior characteristics, the solution yielding the cluster assignments.

8. The method of claim 1, wherein determining the behavior characteristics further comprises selecting a subset of features by solving a QUBO feature-selection formulation, and using the selected subset to compute the behavior characteristics.

9. The method of claim 8, wherein solving the QUBO feature-selection formulation is performed using a quantum or quantum-inspired solver.

10. The method of claim 1, wherein initiating the security action is conditioned on an anomaly score meeting a policy threshold and the action is selected based on a risk tier associated with the anomaly.

11. The method of claim 1, wherein the behavior characteristics are computed over successive time intervals and refreshed in response to changes in the network data.

12. The method of claim 1, further comprising updating the cluster assignments in response to changes in the dynamic network graph without recomputing cluster assignments for nodes that are not affected by the change, and incrementally re-clustering a subset of nodes affected by the changes.

13. A system comprising one or more processors and memory storing instructions that, when executed by the one or more processors, cause the system to:
receive network data describing communications associated with a computer network over successive time intervals;
construct and maintain a dynamic network graph based on the network data, the dynamic network graph comprising nodes representing computing entities and edges representing communications among the nodes;
determine, for the nodes, behavior characteristics based at least in part on the dynamic network graph;
cluster the nodes of the dynamic network graph using a clustering algorithm that processes the behavior characteristics to obtain cluster assignments for the nodes; and
detect anomalies by identifying nodes whose behavior characteristics are inconsistent with characteristics of their respective cluster assignments, and output an alert or initiate a security action in response.

14. The system of claim 13, further comprising validating or refining the cluster assignments by solving a quadratic unconstrained binary optimization (QUBO) formulation whose objective encodes clustering based on the behavior characteristics, and updating one or more cluster assignments in response to the solution.

15. The system of claim 13, wherein the clustering algorithm comprises a density-based clustering algorithm selected from DBSCAN or HDBSCAN.

16. The system of claim 13, wherein clustering the nodes comprises solving a quadratic unconstrained binary optimization (QUBO) formulation whose objective encodes clustering based on the behavior characteristics, the solution yielding the cluster assignments.

17. The system of claim 13, wherein initiating the security action is conditioned on an anomaly score meeting a policy threshold and the action is selected based on a risk tier associated with the anomaly.

18. The system of claim 13, further comprising updating the cluster assignments in response to changes in the dynamic network graph without recomputing cluster assignments for nodes that are not affected by the change, and incrementally re-clustering a subset of nodes affected by the changes.

19. A non-transitory computer-readable medium storing instructions that, when executed by one or more processors, cause the one or more processors to perform operations comprising the method of claim 1.

20. The non-transitory computer-readable medium of claim 19, wherein the operations further comprise updating the cluster assignments in response to changes in the dynamic network graph without full recomputation and incrementally re-clustering a subset of nodes affected by the changes.
